(19) United States
(12) Patent Application Publication
(10) Pub. No.: US 2021/0143448 A1
(43) Pub. Date: May 13, 2021

(54) SOLID-STATE ELECTROCHEMICAL DEVICES HAVING COATED COMPONENTS

(71) Applicants: Bryan M. BLACKBURN, Bethesda, MD (US); Lei WANG, Newark, DE (US); Thomas A. LANGDO, Great Falls, VA (US)

(72) Inventors: Bryan M. BLACKBURN, Bethesda, MD (US); Lei WANG, Newark, DE (US); Thomas A. LANGDO, Great Falls, VA (US)

(21) Appl. No.: 16/680,701

(22) Filed: Nov. 12, 2019

(51) Int. Cl. H01M 8/0245; H01M 8/0232; H01M 8/0282; H01M 8/0236; H01M 8/2432

(52) U.S. Cl. CPC H01M 8/0245; H01M 8/0232; H01M 2008/1293; H01M 8/0236; H01M 8/2432; H01M 8/0282

(57) ABSTRACT

In various embodiments, components such as interconnects and/or endplates of a solid-state electrochemical device are coated with materials such as, for example, graphite, copper, aluminum, carbide ceramics, nitride ceramics, conversion coatings, or aluminum intermetallics.

### GOVERNMENT SUPPORT

This invention was made with United States Government support under Contract No. DE-AR0000494 awarded by the Department of Energy Advanced Projects Research Agency-Energy (ARPA-E). The United States Government has certain rights in the invention.

### TECHNICAL FIELD

In various embodiments, the present invention relates to coatings and materials for components, such as interconnects and/or endplates, for solid-state electrochemical devices such as solid oxide fuel cells.

### BACKGROUND

Solid oxide fuel cells (SOFCs) are a class of solid-state electrochemical cells (or solid-state oxide electrochemical cells), which are highly efficient, environmentally friendly, and capable of directly converting chemical energy stored in fuels such as hydrogen, hydrogen-containing fuels (e.g., ammonia, or NH₃), hydrocarbons, or carbon-containing fuels (e.g., carbon monoxide) into electrical energy. During SOFC operation, ions (e.g., oxygen ions or protons) migrate between a cathode and an anode through a dense solid oxide or ceramic electrolyte. At the anode, an oxidation reaction occurs (i.e., electrons leaving), while at the cathode, a reduction reaction occurs (i.e., electrons entering). For example, for an SOFC with an oxygen-ion conducting solid oxide electrolyte, at the anode, the oxygen ions oxidize the fuel, resulting in the generation of electrons that may be directed through an external circuit. SOFCs may be used for, for example, distributed power generation or even off-grid and portable power generation. Additional solid-state electrochemical devices include solid oxide electrolyzer cells (SOECs) and solid oxide membrane (SOM) reactors.

Various SOFCs utilize a configuration in which multiple cells are stacked together and separated from each other by electrically conductive plates, or interconnects, which also separate the air and fuel streams utilized by the SOFC. Conventional SOFCs operate at elevated temperatures in order to achieve sufficiently high ionic conductivity in the solid electrolyte and generate appreciable electric current output. For example, many SOFCs operate at temperatures ranging from 800° C. to 950° C. and thus require the use of exotic and expensive materials within the SOFC stack. While lower temperature operation is attractive for a variety of reasons (e.g., higher reliability, higher cell efficiency, faster startup times, lower cost, etc.), this regime has been traditionally avoided for conventional SOFCs because the resulting power densities, which decrease with operating temperature for any particular SOFC configuration, have been inadequate.

Therefore, opportunities exist for improving the reliability, cost-effectiveness, and cell efficiency of SOFCs via judicious selection of SOFC stack materials and configurations.

### SUMMARY

In accordance with various embodiments of the present invention, SOFC stack configurations incorporate one or more components including, consisting essentially of, or consisting of aluminum and/or graphite (and/or an alloy, composite, or metal-matrix composite including one or both) to address a variety of issues, including, e.g., one or more of heat transfer, mechanical stress, seal leakage, cost, and weight. Exemplary metal-matrix composites in accordance with embodiments of the invention include composites of Al with one or more of alumina, silicon carbide, graphite, or carbon nanotubes. In such composites, the non-Al component may be present as particles, fibers, whiskers, platelets, etc. in the Al matrix, for increased strength and/or stiffness.

In various embodiments, aluminum may be alloyed or replaced with copper in one or more of the SOFC components; thus, herein, references to aluminum may be understood to mean “aluminum and/or copper” unless otherwise indicated. In addition, it is understood that “aluminum” refers to metallic aluminum (and/or metallic copper) and does not include ceramic materials including aluminum (and/or copper) such as alumina; embodiments of the invention may be free of alumina, except in the form of surface passivation layers due to, e.g., oxidation of aluminum in air (that is, embodiments of the invention are free of alumina, at least in the bulk of the object away from the surface). (Note that composites or metal-matrix composites containing aluminum may also contain a ceramic phase that may include, consist essentially of, or consist of alumina.) Herein, objects comprising aluminum contain aluminum as the primary constituent (i.e., no other metals or other elements are present in larger mass or volume fractions); for example, aluminum objects may contain at least 50%, at least 60%, at least 75%, at least 90%, at least 95%, or at least 99% aluminum. In various embodiments, the copper may be in the form of nickel-clad or nickel-coated copper, or even aluminum-clad or aluminum-coated copper. In various embodiments, one alloy of aluminum (or pure aluminum) may clad another type of aluminum alloy.

In addition, as utilized herein, “graphite” includes other non-diamond forms of carbon, including graphene, exfoliated graphite, flake graphite, amorphous graphite, crystalline graphite, pyrolytic graphite, highly ordered pyrolytic graphite (HPOG), pyrolytic carbon, carbon black, activated carbon, carbon fiber, graphene, polycrystalline graphite, synthetic graphite, and/or glass-like carbon (e.g., glassy or vitreous carbon). Herein, objects comprising graphite contain graphite as the primary constituent (i.e., no other metals or other elements are present in larger mass or volume fractions, as opposed to, for example, objects such as gaskets having carbon present therein as a binder, pore former, etc.); for example, graphite objects may contain at least 50%, at least 60%, at least 75%, at least 90%, at least 95%, or at least 99% graphite. SOFCs with configurations in accordance with embodiments of the invention may be beneficially operated at lower temperatures (e.g., temperatures ranging from approximately 400° C. to approximately 850° C., approximately 400° C. to approximately 700° C., or from approximately 400° C. to approximately 550° C.). In various embodiments of the invention, aluminum, copper, and/or graphite may be incorporated within SOFC components such as interconnects, endplates, and/or seals.

In various embodiments, the use of aluminum, copper, and/or graphite results in better temperature spreading within the SOFC stack and concomitant reduction or elimination of deleterious thermal gradients within the SOFC stack. These materials have relatively high thermal conductivities (approximately 237 W/m-K for aluminum, approximately 128-400 W/m-K for graphite, and approximately 385 W/m-K for copper, compared to approximately 16-25 W/m-K for stainless steel), facilitating such thermal spreading within the SOFC stack. In addition, aluminum has a superior volume-specific heat capacity (approximately 2430 kJ/m³/K) compared to that of stainless steel (approximately 3760 kJ/m³/K), resulting in better thermal response of the SOFC stack to conditions such as startup, load following, and changes in fuel composition.

In various embodiments, coatings are used to coat one or more SOFC stack components. In various embodiments, coatings may include, consist essentially of, or consist of nickel, silver, manganese cobalt oxide (MCO), aluminum, aluminum intermetallics (e.g, TiAl, MgAl, FeAl, NiAl, NiAl₃, Ni₃Al, NiAl₂, Ni₂Al₃, etc.), graphite, nitrides (e.g., TiN, TiAlN, ZrN, tantalum nitride, tungsten nitride, etc.), carbides (e.g., TiC, SiC, TaC, NbC, ZrC, WC, etc.), and/or conversion coatings (e.g., chromate conversion processes such as Iridite NCP, or phosphate conversion coatings including those based on Ca, Ba, Zn, Mn, or Fe). (As known to those of skill in the art, conversion coatings are coatings in which the component's surface is subjected to a chemical or electro-chemical process by the coating material that converts it into another substance.)

In various embodiments, the structure of a conversion coating may include, consist essentially of, or consist of two or more layers on top of a substrate. In various embodiments, the first layer is an interfacial layer with one or more conversion coating film layers existing on top of the first layer. In various embodiments, the interfacial layer may include, consist essentially of, or consist of a mixture of elements in the substrate material and one or more elements of conversion coating film, or one or more elements from various compounds (e.g., halides such as fluorides, chlorides, bromides, or iodides; phosphates or phosphides; and sulfates or sulfides) present in the conversion coating solution. In various embodiments, an additional layer or layers between an interfacial layer and an outer conversion coating film layer may include, consist essentially of, or consist of a graded composition that ranges between the composition of the other layers. In various embodiments, the substrate may include, consist essentially of, or consist of aluminum, an aluminum alloy, copper, a copper alloy, or a stainless steel (e.g., austenitic (300 series) or ferritic (400 series) varieties). In various embodiments, the elements that may be present in the interface film may include, consist essentially of, or consist of Al, Cu, Fe, Ni, F, P, S, Br, I, K, and/or Cl. In various embodiments, oxygen is additionally present in the interfacial film. In various embodiments, the conversion coating film layer may also include, consist essentially of, or consist of transition metals (e.g., Mo, Zr, Ti, W, Cr, Mn, V, W, Fe, Co, Ni, Cu, or Zn) and/or rare earths (e.g., Ce, La, Nd, or Pr). In various embodiments, the conversion coating film layer is much thicker than the interfacial layer. In various embodiments, the interfacial layer thickness ranges between approximately 0.001 microns and approximately 0.01 microns, while the total thickness of the conversion coating film layer(s) ranges between approximately 0.025 microns and approximately 10 microns. In various embodiments, the interfacial layer thickness ranges between approximately 0.002 microns and approximately 0.006 microns, while the total thickness of the conversion coating film layer(s) ranges between approximately 0.05 microns and approximately 5 microns. In various embodiments, the interfacial layer thickness ranges between approximately 0.002 microns and approximately 0.006 microns, while the total thickness of the conversion coating film layer(s) ranges between approximately 0.075 microns and approximately 3 microns.

There are various commercially available processes and chemical solutions for depositing chemical conversion coatings. Iridite NCP is a fluoride solution including zirconium and tungsten with a final film that may include, consist essentially of, or consist of Zr, F, and W. Chemeon TCP-HF is a chromium (III) sulfate (Cr₂(SO₄)₃) solution including zirconium with a final film that may include, consist essentially of, or consist of Cr, K, Na, S, Zr and small amounts of Pr and Ca. Henkel Alodine 5200 is a potassium hexafluorozirconate (K₂ZrF₆) and hexafluorotitanic acid (H₂TiF₆) solution that results in a film that may include, consist essentially of, or consist of Ti, Zr, K, and F.

A coating or coatings may be deposited on all or part of one or more surfaces of aluminum, copper, or graphite stack components (e.g., interconnects, terminal interconnects, and/or endplates). The coatings may also be deposited on all or part of one or more surfaces of stack components made of materials other than aluminum, copper, or graphite. For example, the coatings may be deposited on stainless steel (e.g., 300-series stainless steel such as 304 or 316; 400-series stainless steel such as 430, 440, or 441; high-temperature nickel alloys such as Inconel or Hastelloy; and more exotic materials sometimes used in SOFC stacks such as Crofer APU 22). In various embodiments the coatings are formed via joining of two or more materials through mechanical bonding and metallurgical (i.e., a cladding) and optional additional heat treatment with subsequent diffusion and creation of an interfacial layer between the two or more materials. Unlike coatings, a cladding may result in a very dense layer that also covers a large range of possible thicknesses. In various embodiments, the cladding thickness may vary between approximately 125 microns and approximately 5 mm. In various embodiments, the cladding thickness may vary between approximately 250 microns and approximately 3 mm. In various embodiments, the cladding thickness may vary between approximately 300 microns and approximately 1 mm. In various embodiments, the outer layer of the cladding is approximately 2% to 60% of the total thickness of the part (i.e., the thickness of the core and clad layers together). In various embodiments, the outer layer of the cladding is approximately 5% to 50% of the total thickness of the part (i.e., the thickness of the core and clad layers together). In various embodiments, the outer layer of the cladding is approximately 10% to 35% of the total thickness of the part (i.e., the thickness of the core and clad layers together). In various embodiments, the outer layer of the cladding is approximately 20% to 30% of the total thickness of the part (i.e., the thickness of the core and clad layers together).

A very dense cladding may lessen or prevent the diffusion of undesirable species (e.g., oxygen) from reaching a core material, which may have the result of avoiding, for instance, undesirable oxidation of the core. In various embodiments, the cladding layer may have an open and/or closed porosity of approximately 0% to approximately 5%. In various embodiments, the cladding layer may have an open porosity (i.e., through porosity) and/or closed porosity of approximately 0% to approximately 3%. In various embodiments, the cladding layer may have an open porosity and/or closed porosity of approximately 0% to approximately 1%. In various embodiments, the cladding layer may have an open porosity and/or closed porosity of approximately 0% to approximately 0.5%. In various embodiments, the cladding layer may have an open porosity and/or closed porosity of approximately 0% to approximately 0.1%.

In various embodiments, the cladding may also equal the same thickness as the layer to which the cladding bonds (i.e., there is no substrate). In various embodiments, the cladding may be thicker than the layer to which the cladding bonds when there is a cladding layer on either side of a core layer. In various embodiments, the cladding is overlay on the core (i.e., covering all or a portion of an outer surface of the core). In various embodiments, the cladding is inlay on the core (i.e., embedded in all or a portion the core). In various embodiments, the cladding is into and/or along the edge of a core. In various embodiments, the cladding may include, consist essentially of, or consist of some combination of an overlay clad, inlay clad, or edge clad layering. In various embodiments, the cladding may include, consist essentially of, or consist of a covering of the entire outer surface of the core layer.

In various embodiments, a stack component, such as an interconnect or endplate, may include, consist essentially of, or consist of one or more layers of aluminum, copper, titanium, or nickel bonded to at least one additional material. In various embodiments, a stack component, may include, consist essentially of, or consist of stainless steel, high-temperature nickel alloy, copper, aluminum, nickel, or graphite material with one or more layers of aluminum, copper, titanium, or nickel. In various embodiments, a stack component, may include, consist essentially of, or consist of a core material or substrate material has a layer of aluminum, copper, titanium, or nickel bonded to multiple sides of the core material or substrate material. In various embodiments, a stack component (e.g., an interconnect), may include, consist essentially of, or consist of a stainless steel core or substrate (e.g., 430 or 441 stainless steel), with a layer of nickel on both sides of the component (e.g., on both the cathode and anode side). In various embodiments, a stack component (e.g., an interconnect), may include, consist essentially of, or consist of a stainless steel core or substrate (e.g., 430 or 441 stainless steel), with a layer of nickel on one side of the component (e.g., on the anode side) and a layer of aluminum on the other side of the component (e.g., on the cathode side). In various embodiments, a stack component (e.g., an interconnect), may include, consist essentially of, or consist of an additional one or more layers in contact with either one or both of the outer layer or layers of, for instance, the clad core. In various embodiments, a stack component (e.g., an interconnect), may include, consist essentially of, or consist of a stainless steel core or substrate (e.g., 430 or 441 stainless steel), with a layer of nickel on one side of the component (e.g., on the anode side) and a layer of aluminum on the other side of the component (e.g., on the cathode side), wherein an additional coating (e.g., a nitride such as TiN or a carbide such as SiC) is on top of the aluminum layer. In various embodiments, one or more alloys of aluminum (e.g., an alloy from the 1XXX or 6XXX series) may clad another type of aluminum alloy (e.g., an alloy from the 2XXX series) to get an enhanced combination of, for instance, strength and corrosion resistance.

In various embodiments, seals/gaskets are used to seal SOFC stack components. (Herein, “seal” and “gasket” are utilized interchangeably unless otherwise indicated.) In various embodiments, seals include, consist essentially of, or consist of mica, vermiculite, glass, brazing alloys, asbestos, polyamides (e.g., aramid), talc, polyimides (e.g., Kapton), polyamide-imides (e.g., Torlon), polysiloxanes (e.g., silicone), and/or silsesquioxanes (e.g., phenyl silsesquioxane). The seal materials may be used as standalone seals within the SOFC stack, or two or more seal materials may be utilized together as hybrid seals. For example, a polysiloxane, polyimide, polyamide-imide, or silsesquioxane may be coated on to all or a portion of a mica or vermiculite gasket. Alternatively, two separate gaskets may simply be stacked on top of each other (with or without an adhesive therebetween) to form a hybrid seal. In various embodiments, seals may also be composite seals that include, consist essentially of, or consist of two or more materials. For example, a polysiloxane, polyimide, polyamide-imide, or silsesquioxane may be mixed together with mica, talc, or vermiculite to form a seal. In various embodiments, composite seals include at least 20%, at least 30%, or even at least 40% of a polymeric or other carbon-based material. The seals may be used to seal ceramic components (e.g., a cell) with stack components made of aluminum, copper, or graphite, or between stack components made of aluminum, copper, or graphite. The seals may also be used to seal ceramic components (e.g., a cell) to stainless steel or other stack components (e.g., 300-series stainless steel such as 304 or 316; 400-series stainless steel such as 430, 440, or 441; high-temperature nickel alloys such as Inconel or Hastelloy; and more exotic materials sometimes used in SOFC stacks such as Crofer APU 22).

SOFC devices in accordance with embodiments of the invention may also exhibit superior mechanical properties when compared to conventional devices. For example, the specific strength of aluminum (approximately 115 kN-m/kg) is higher than that of stainless steel (approximately 63.1 kN-m/kg), and aluminum is also much less likely to be embrittled by hydrogen exposure than materials such as stainless steel. SOFC component materials in accordance with embodiments of the invention such as aluminum and graphite are also at least approximately three times lighter than stainless steel or other exotic high-temperature metal alloys, decreasing the weight of the SOFC stack and easing mechanical strength requirements.

Fuel cell stacks for certain types of fuel cells (e.g., low temperature polymer electrolyte membrane (PEM) fuel cells (also known as proton exchange membrane fuel cells) and solid acid fuel cells (SAFCs)) may also utilize aluminum and/or graphite stack components. However, these types of fuel cells are not ceramic-based and are limited to operating temperatures of ˜100° C. for typical PEM fuel cells; ˜200° C. for high-temperature PEM fuel cells; and ˜300° C. for SAFC technology. SOFCs operate at higher temperatures (e.g., 400° C. to 900° C., or even as low as 350° C. is theoretically possible). PEM fuel cells use polymer electrolytes and SAFCs use solid acid electrolytes, where a solid acid is a chemical intermediate between salt and acid. SOFCs in accordance with various embodiments of the invention are oxygen ion conductors, as opposed to hydronium ion (H30⁺) conductors such as PEM fuel cells and proton conductors such as SAFCs (although, as explained in greater detail below, some SOFCs in accordance with embodiments of the invention are proton-conducting). Unlike PEM fuel cells and SAFCs, SOFCs and other device in accordance with embodiments of the present invention utilize ceramic electrolytes.

As utilized herein, a “ceramic” is a solid material that comprises an inorganic compound of metal, non-metal or metalloid atoms primarily held in ionic and covalent bonds. This includes oxides, nitrides, borides, carbides, silicides, and silicates of all metals and non-metallic elemental solids. A ceramic may be a combination of one or more non-metallic elemental solids (e.g., SiC), or between a metal and non-metallic elemental solid (e.g., TiC). In contrast, SAFCs typically feature a solid acid, which is essentially acid protons (e.g., H₂SO₄) incorporated into a crystalline salt structure (e.g., Cs₂SO₄); the salt has only ionic bonds and so the solid acid primarily has hydrogen bonds and ionic bonds. In addition, hydrogen is part of the molecular crystal structure of typical SAFC materials (of the form MₐH_{b}(XO₄)_{c}, where M is monovalent or divalent cation and XO₄ is a tetrahedral oxy-anion) and forms a hydrogen-bonded network that links the oxyanion groups to form a 3D structure (and, at times, also form dimers or chains). Hydrogen is not part of the crystal structure of ceramic proton-conducting electrolytes. The ceramic proton conductors tend to be perovskites. During operation of a device using a ceramic proton-conducting material, hydrogen may be incorporated into the crystal structure (e.g., as interstitials and/or in vacancies) but it is not part of the crystal structure. Thus, embodiments of the invention include SOFCs incorporating proton-conducting ceramic electrolytes. Aluminum and aluminum alloys have a relatively low melting temperature and form an electrically resistive oxidation layer, which may result in structural stability issues and prohibitively high resistance in SOFC operating conditions, respectively. Most SOFCs operate at high temperatures (e.g., ≥800° C.), and therefore developers/researchers typically utilize coated stainless steel to avoid surface oxidation and resultant increase in resistance. The thermal expansion coefficient of Al is roughly twice that of stainless steel and the SOFC. Thermal mismatch may result in cracked SOFCs or stack leaks. Moreover, even though PEMFCs or SAFCs may in some instances use aluminum or aluminum alloys in SOFC stack components, the upper practical operation temperature for such fuel cells (e.g., ˜300° C.) is far enough from the bottom-end operation temperature for advanced SOFCs (e.g., ˜400° C.) that such problems that may occur with use of aluminum or copper in SOFC stacks simply are not an issue (or the same issue) for PEMFCs or SAFCs. For these reasons, aluminum- and aluminum alloy-based components have not previously been used in SOFCs, SOECs, SOMs, and related devices. The situation for copper is similar.

Conventional SOFCs typically use glass and/or ceramic seals, in part due to the high operating temperatures of SOFCs (usually >800° C.). Typically, graphite oxidizes and begins to decompose at temperatures above ˜500° C., which is one reason why graphite-based stack components have not previously been used in SOFCs, SOECs, SOMs, and related devices. Moreover, the thermal expansion coefficient (TEC) of graphite is anisotropic, but the through-thickness TEC of graphite can be about two to three times that of the SOFC or conventional stainless steel stack components. The in-plane TEC is typically less than one-half that of the SOFC or conventional stainless steel stack components. Special nuclear grades of graphite components have been designed to be more isotropic or semi-isotropic, with more uniform TECs in all directions that are approximately less than 60% that of the SOFC or conventional stainless steel stack components. In addition, even though PEMFCs or SAFCs may in some instances use graphite, the upper practical operation temperature for such fuel cells (e.g., ˜300° C.) is far enough from the bottom end operation temperature for advanced SOFCs (e.g., ˜400° C.) that such problems that may occur with use of graphite in SOFC stacks simply are not an issue (or the same issue) for PEMFCs or SAFCs. Polymer-based seals have relatively low decomposition temperatures and can also oxidize at relatively low temperatures, which may negatively impact the structural integrity of the seal and lead to leaks in a stack. The melting point and decomposition temperatures of most polymers are well below the minimum operating temperature range of SOFCs (e.g., ≤350° C.). Since typical SOFCs operate above 800° C., developers and researchers would not be motivated to attempt to use polymer seals. Even at the lower temperature range of SOFC operation (e.g., 400-550° C.), researchers would not be motivated to use polymer seals because of the risk for oxidation and subsequent leaks, especially with the use of conventional polymer seals.

Carbide and nitride coatings tend to oxidize and or decompose at high temperatures. Moreover, in many cases the electrical conductivity of carbides and nitrides decreases with increasing temperature. Finally, as temperature increases, there is an increased risk that the coating and the substrate (e.g., interconnect) or the coating and the SOFC cell will react and decrease SOFC performance or react to create undesirable (e.g., insulating) phases or scale on the interconnect that decrease SOFC stack performance. Since typical SOFCs operate above 800° C., developers and researchers would not be motivated to attempt to use nitride or carbide coatings without additional structures or layers present to prevent oxidation and other undesirable reactions from occurring between materials. Moreover, even though PEMFCs or SAFCs may in some instances use carbide and nitride coatings, the upper practical operation temperature for such fuel cells (e.g., ˜300° C.) is far enough from the bottom end operation temperature for advanced SOFCs (e.g., ˜400° C.) that such problems that may occur for SOFCs simply are not an issue for PEMFCs or SAFCs. The same may be said of aluminum intermetallics and conversion coatings.

SOFCs in accordance with embodiments of the invention utilize solid ceramic and/or solid oxide electrolytes and may be operated at temperatures of at least 400° C. (As utilized herein, a “ceramic electrolyte” is understood to include electrolytes including, consisting essentially of, or consisting of “solid oxides.”) Thus, SOFCs in accordance with embodiments of the invention do not incorporate polymer-based cells or polymer-based cell components (e.g., polymer electrolytes), liquid-humidified membranes, liquid electrolytes, solid-acid electrolytes (e.g., solid-acid fuel cells), or molten-salt electrolytes (e.g., molten carbonate fuel cells). (Note that solid-acid electrolytes, such as CsH₂PO₄, are not ceramic electrolytes for SOFCs as defined herein. Solid acids are a class of compounds where protonated “acid” protons (e.g., H₂SO₄) are incorporated into a crystalline structure (e.g., ½Cs₂SO₄+½H₂SO₄→CsHSO₄). The electrolyte in a solid-acid fuel cell is typically a proton-conducting oxyanion salt, and not a ceramic or ceramic oxide.)

Various embodiments of the present invention incorporate thin functional layers between the electrolyte and the cathode (i.e., cathode functional layers) in order to, e.g., reduce the interfacial resistance between the electrolyte and the cathode, as disclosed in U.S. patent application Ser. Nos. 15/461,708 and 15/461,709 (the '708 and '709 applications), both filed on Mar. 17, 2017, the entire disclosures of which are incorporated by reference herein. For example, the functional layer may include, consist essentially of, or consist of cobalt mixed with gadolinium-doped ceria (Co-GDC, for example, Co₃O₄—Ce_{0.9}Gd_{0.1}O_{1.95} or cobalt-doped Ce_{0.9}Gd_{0.1}O_{1.95}) or cobalt mixed with samarium doped ceria (Co-SDC, for example, Co₃O₄—Ce_{0.8}Sm_{0.2}O_{1.9} or cobalt-doped Ce_{0.8}Sm_{0.2}O₁₉), and the functional layer may be disposed and in direct contact with the solid electrolyte and the cathode material.

Embodiments of the invention may also utilize thin functional layers between the electrolyte and the anode (i.e., anode functional layers), which provide enhanced chemical, mechanical, and/or electrochemical compatibility between the anode support layer (ASL) and electrolyte and/or provide enhanced electrocatalytic activity. An anode functional layer may have a different composition (which may be graded), particle size, tortuosity, and/or geometry than the ASL.

SOFCs are utilized herein as exemplary devices in descriptions of embodiments of the present invention, but it should be understood that embodiments of the invention also encompass other types of solid-state electrochemical cells. For example, a second type of solid-state electrochemical cell is known as a solid-oxide electrolyzer cell (SOEC), which resembles an SOFC that runs in reverse. In other words, the SOEC takes electricity as an input to drive the reverse reaction of the SOFC, where water (and/or carbon dioxide) is converted into hydrogen (and/or carbon monoxide) at the fuel (or hydrogen) electrode and oxygen at the oxygen electrode. When the electrolyte in the SOEC is a proton conductor, the oxygen electrode may also be called a steam electrode. The SOEC is an electrolytic cell involving the transformation of electrical energy into chemical energy, whereas the SOFC is a galvanic cell involving the transformation of chemical energy into electrical energy. Like the SOFC, the SOEC typically operates between 500° C. and 800° C. (or potentially as low as approximately 400° C.) and is a layered structure including, consisting essentially of, or consisting of a solid oxide (ceramic) electrolyte, a fuel electrode, and an oxygen electrode. For example, in electrolytic, SOEC mode, the fuel electrode is the cathode, and the oxygen electrode is the anode. The most common electrolyte of SOECs, similar to SOFCs, is a dense ionic conductor that includes yttria stabilized zirconia (YSZ). Some other choices are scandia-stabilized zirconia (ScSZ), doped ceria-based electrolytes, or lanthanum gallate materials. The most common fuel-electrode material is a Ni-YSZ cermet. A cermet is a metal-ceramic composite material. Perovskite-type lanthanum strontium manganese (LSM) is one of the most common oxygen-electrode materials, though other materials are possible. SOECs may be planar or tubular just like SOFCs. SOEC electrolytes may also conduct protons rather than oxygen ions. Furthermore, the SOEC may in certain cases be exactly the same as the SOFC and used in both SOFC mode and SOEC mode. This is known as a reversible or regenerative fuel cell.

A third type of solid-state electrochemical cell is known as solid oxide membrane (SOM) reactor, or an electrocatalytic reactor. The reactors have two chambers that are separated by a solid oxide, gas-tight ceramic electrolyte or membrane that is capable of transporting oxide ions (and/or protons) at elevated temperatures (typically between 600° C. and 1,000° C.). Such electrochemical cells may operate in electrolytic mode to convert input feedstock chemicals (e.g., CH₄) into other higher value chemicals (e.g., ethylene) and/or reactions may be driven through pressure or concentration gradients on either side of the membrane. Catalysts in each chamber may increase selectivity to a product by offering reaction sites and/or creating reaction pathways that are more favorable to certain products than others. SOM reactors have also been used to drive partial oxidation reactions of methane to form syngas (mostly hydrogen and carbon monoxide), oxidative coupling of methane (OCM) to form ethane and ethylene, and even the generation of high-purity oxygen from air. SOM reactors may be planar or tubular just like SOFCs.

The disclosure and embodiments of the invention apply to solid oxide electrochemical cell devices other than SOFCs, including “SOECs,” reversible or regenerative SOFCs, “SOMs,” electrocatalytic reactors, or other solid-state electrochemical cells and related devices. Herein, references to SOFCs may be understood to include and encompass “SOECs”, reversible or regenerative SOFCs, “SOMs”, electrocatalytic reactors, or other solid-state electrochemical cells and related devices, unless otherwise indicated. The terms used for the different electrodes and electrolytes in the different devices may differ due to the mode of operation under which the device typically operates (e.g., galvanic versus electrolytic) or due to the gaseous byproducts or reactants that are flowed on a particular side of the device during operation. The anode is where oxidation occurs (i.e., electrons leave the electrode). The cathode is where reduction occurs (i.e., electrons enter into the electrode). In an electrolytic operating mode (e.g., such as with an SOEC), the anode may be known as the oxygen electrode (e.g., the side of the device where an oxygen source is flowed), while the cathode may be known as the fuel electrode or hydrogen electrode (e.g., the side of the device where “fuel” flows). When the electrolyte in the SOEC is a proton conductor, the oxygen electrode may also be called a steam electrode, because steam is often the oxygen source. Typical anode, cathode, and overall reactions for various types of devices in accordance with embodiments of the present invention include:

### SOFC

Anode: 2H₂+2O²⁻→2H₂O+4e⁻
Cathode: O₂+4e^{Δ}→2O²⁻
Overall: 2H₂+O₂→2H₂O

### PC-SOFC (Proton Conducting)

Anode: H₂→2H⁺+2e⁻
Cathode: ½O₂+2H⁺+2e⁻→H₂O
Overall: H₂+½O₂→H₂O

### SOEC

Anode: O^{2Δ}→½O₂+2e⁻(O₂ electrode)
Cathode: H₂O+2e⁻→H₂+O²⁻(fuel or H₂ electrode)
Overall: H₂O→H₂+½O₂

### P-SOEC (Proton Conducting)

Anode: H₂O→2H⁺+½O₂+2e⁻
Cathode: 2H⁺+2e⁻→H₂
Overall: H₂O→H₂+½O₂

### Electrochemical/Electrocatalytic Reduction of CO₂ (Oxygen Ion Conductor)

Anode: 2O^{2Δ}→O₂+4e⁻
Cathode: 2CO₂+4e⁻→2CO+2O²⁻
Overall: 2CO₂→2CO+O₂

In an aspect, embodiments of the invention feature a solid oxide fuel cell device that includes, consists essentially of, or consists of a bottom endplate, a top endplate, and one or more repeat units disposed between the top and bottom endplates. Each repeat unit includes, consists essentially of, or consists of a cell, a solid, electrically conductive interconnect plate, and a seal. The cell includes, consists essentially of, or consists of (i) a cathode, (ii) a solid ceramic electrolyte, and (iii) an anode for producing electricity through oxidation and reduction reactions involving a fuel and an oxygen source. The interconnect plate conducts electrical current from the cell. The seal is disposed between the interconnect plate and the cell at least at a periphery of the repeat unit. The seal reduces gas leakage from the repeat unit. The interconnect plate and the cell are electrically insulated from each other at the seal. In the device, (i) the interconnect plate includes, consists essentially of, or consists of graphite, aluminum, and/or copper, (ii) the seal includes, consists essentially of, or consists of graphite, and/or (iii) the bottom endplate and/or the top endplate includes, consists essentially of, or consists of graphite, aluminum, and/or copper.

Embodiments of the invention may include one or more of the following in any of a variety of combinations. The repeat units may be electrically connected in series. The seal may include, consist essentially of, or consist of graphite. The interconnect plate may not include, consist essentially of, or consist of graphite, aluminum, or copper. The interconnect plate may include, consist essentially of, or consist of stainless steel and/or a nickel-based superalloy. The interconnect plate may include, consist essentially of, or consist of graphite, aluminum, and/or copper. The seal may not include, consist essentially of, or consist of graphite. The seal may include, consist essentially of, or consist of glass, one or more brazing alloys, talc, mica, vermiculite, asbestos, a ceramic material, and/or a polymer material. The bottom endplate and/or the top endplate may include, consist essentially of, or consist of graphite, aluminum, and/or copper. The interconnect plate may not include, consist essentially of, or consist of graphite, aluminum, or copper. The interconnect plate may include, consist essentially of, or consist of stainless steel and/or a nickel-based superalloy. The interconnect plate may include, consist essentially of, or consist of graphite, aluminum, and/or copper. The seal may not include, consist essentially of, or consist of graphite. The seal may include, consist essentially of, or consist of glass, one or more brazing alloys, talc, mica, vermiculite, asbestos, a ceramic material, and/or a polymer material. The seal may include, consist essentially of, or consist of graphite. The interconnect plate may include, consist essentially of, or consist of graphite, aluminum, and/or copper.

The device may include a coating disposed on the interconnect plate, the bottom endplate, and/or the top endplate. The coating may include, consist essentially of, or consist of graphite, copper, aluminum, a carbide ceramic, a nitride ceramic, a conversion coating, and/or an aluminum intermetallic. The interconnect plate may define a plurality of protruding contact features for electrically connecting the interconnect plate to the cell. An electrically conductive coating or cladding may be disposed over at least top surfaces of the contact features. The interconnect plate may define one or more flow channels for conduction of the fuel and/or of the oxygen source therethrough. An electrically conductive porous or mesh current collector may be disposed between and in contact with the cell and the interconnect plate. An external seal may be disposed around the periphery of the repeat unit and may encapsulate the interconnect plate and/or the seal to reduce oxidation thereof. The device may include an electrically insulating first layer and/or an electrically insulating second layer. The first layer may be disposed between the seal and the interconnect plate. The second layer may be disposed between the seal and the cell. The seal may include, consist essentially of, or consist of first and second layers. The first and second layers may include, consist essentially of, or consist of different materials. The first layer and/or the second layer may be electrically conductive. The device may include an electrically insulating first coating disposed on a first surface of the seal, and/or an electrically insulating second coating disposed on a second surface of the seal opposite the first surface. The one or more repeat units may be electrically connected to the top endplate and the bottom endplate. The one or more repeat units may not be electrically connected to the top endplate and the bottom endplate. A top terminal interconnect plate may be disposed between the top endplate and the plurality of repeat units. The top terminal interconnect plate may be electrically connected to the plurality of repeat units. A bottom terminal interconnect plate may be disposed between the bottom endplate and the plurality of repeat units. The bottom terminal interconnect plate may be electrically connected to the plurality of repeat units. A peripheral edge of the interconnect plate may be shaped to directly contact the cell of an adjacent repeat unit without a seal therebetween.

In another aspect, embodiments of the invention feature a solid oxide fuel cell device that includes, consists essentially of, or consists of a bottom endplate, a top endplate, and, disposed between the top and bottom endplates, (i) a cell, (ii) a solid, electrically conductive first interconnect plate, (iii) a solid, electrically conductive second interconnect plate, (iv) a first seal, and (v) a second seal. The cell has a top surface and a bottom surface opposite the top surface. The cell includes, consists essentially of, or consists of (i) a cathode, (ii) a solid ceramic electrolyte, and (iii) an anode for producing electricity through oxidation and reduction reactions involving a fuel and an oxygen source. The first interconnect plate is disposed over the top surface of the cell and is electrically connected to the cell. The second interconnect plate is disposed below the bottom surface of the cell and is electrically connected to the cell. The first seal is disposed between the first interconnect plate and the cell at least at a periphery of the first interconnect plate. The first interconnect plate and the cell are electrically insulated from each other at the first seal. The second seal is disposed between the second interconnect plate and the cell at least at a periphery of the second interconnect plate. The second interconnect plate and the cell are electrically insulated from each other at the second seal. In the device, (i) the first interconnect and/or the second interconnects includes, consists essentially of, or consists of graphite, aluminum, and/or copper, and/or (ii) the first seal and/or the second seal includes, consists essentially of, or consists of graphite.

Embodiments of the invention may include one or more of the following in any of a variety of combinations. A spacer may be disposed around a peripheral edge of the cell and between the first seal and the second seal. An external seal may be disposed around and may encapsulate an outer peripheral edge of the first interconnect plate, the second interconnect plate, the first seal, and/or the second seal. An electrically conductive porous or mesh first current collector may be disposed between and in contact with the cell and the first interconnect plate. An electrically conductive porous or mesh second current collector may be disposed between and in contact with the cell and the second interconnect plate. The device may include an electrically insulating first layer disposed between the first seal and the first interconnect plate, an electrically insulating second layer disposed between the first seal and the cell, an electrically insulating third layer disposed between the second seal and the second interconnect plate, and/or an electrically insulating fourth layer disposed between the second seal and the cell. The first seal may include, consist essentially of, or consist of first and second layers. The first and second layers may include, consist essentially of, or consist of different materials. The second seal may include, consist essentially of, or consist of third and fourth layers. The third and fourth layers may include, consist essentially of, or consist of different materials. The device may include an electrically conductive first coating disposed on a surface of the first interconnect plate facing the top surface of the cell, and/or an electrically conductive second coating disposed on a surface of the second interconnect plate facing the bottom surface of the cell.

The first seal and/or the second seal may include, consist essentially of, or consist of graphite. The first interconnect plate and/or the second interconnect plate may not include, consist essentially of, or consist of graphite, aluminum, or copper. The first interconnect plate and/or the second interconnect plate may include, consist essentially of, or consist of stainless steel and/or a nickel-based superalloy. The first interconnect plate and/or the second interconnect plate may include, consist essentially of, or consist of graphite, aluminum, and/or copper. The first seal and/or the second seal may not include, consist essentially of, or consist of graphite. The first seal and/or the second seal may include, consist essentially of, or consist of glass, one or more brazing alloys, talc, mica, vermiculite, asbestos, a ceramic material, and/or a polymer material. A coating may be disposed on the first interconnect plate, the second interconnect plate, the bottom endplate, and/or the top endplate. The coating may include, consist essentially of, or consist of graphite, copper, aluminum, a carbide ceramic, a nitride ceramic, a conversion coating, and/or an aluminum intermetallic.

In yet another aspect, embodiments of the invention feature a solid oxide fuel cell device that includes, consists essentially of, or consists of a bottom endplate, a top endplate, and, disposed between the top and bottom endplates, (i) a cell, (ii) a solid, electrically conductive first interconnect plate, (iii) a solid, electrically conductive second interconnect plate, and (iv) a seal disposed between the second interconnect plate and the cell at least at a periphery of the second interconnect plate. The cell has a top surface and a bottom surface opposite the top surface. The cell includes, consists essentially of, or consists of (i) a cathode, (ii) a solid ceramic electrolyte, and (iii) an anode for producing electricity through oxidation and reduction reactions involving a fuel and an oxygen source. The first interconnect plate is disposed over the top surface of the cell and electrically connected to the cell. A peripheral edge of the first interconnect plate is disposed in direct mechanical contact with the cell. The second interconnect plate is disposed below the bottom surface of the cell and electrically connected to the cell. The second interconnect plate and the cell are electrically insulated from each other at the seal. In the device, (i) the first interconnect and/or the second interconnect includes, consists essentially of, or consists of graphite, aluminum, and/or copper, and/or (ii) the seal includes, consists essentially of, or consists of graphite.

Embodiments of the invention may include one or more of the following in any of a variety of combinations. A spacer may be disposed around a peripheral edge of the cell and between the first interconnect plate and the seal. The device may include a first external seal disposed around and encapsulating an outer peripheral edge of the first interconnect plate, and/or a second external seal disposed around and encapsulating an outer peripheral edge of the second interconnect plate. The device may include an electrically conductive porous or mesh first current collector disposed between and in contact with the cell and the first interconnect plate, and/or an electrically conductive porous or mesh second current collector disposed between and in contact with the cell and the second interconnect plate. The device may include an electrically insulating first layer disposed between the seal and the second interconnect plate, and/or an electrically insulating second layer disposed between the seal and the cell. The seal may include, consist essentially of, or consist of first and second layers. The first and second layers may include, consist essentially of, or consist of different materials. The device may include an electrically conductive first coating disposed on a surface of the first interconnect plate facing the top surface of the cell, and/or an electrically conductive second coating disposed on a surface of the second interconnect plate facing the bottom surface of the cell.

The seal may include, consist essentially of, or consist of graphite. The first interconnect plate and/or the second interconnect plate may not include, consist essentially of, or consist of graphite, aluminum, or copper. The first interconnect plate and/or the second interconnect plate may include, consist essentially of, or consist of stainless steel and/or a nickel-based superalloy. The first interconnect plate and/or the second interconnect plate may include, consist essentially of, or consist of graphite, aluminum, and/or copper. The seal may not include, consist essentially of, or consist of graphite. The seal may include, consist essentially of, or consist of glass, one or more brazing alloys, talc, mica, vermiculite, asbestos, a ceramic material, and/or a polymer material. A coating may be disposed on the first interconnect plate, the second interconnect plate, the bottom endplate, and/or the top endplate. The coating may include, consist essentially of, or consist of graphite, copper, aluminum, a carbide ceramic, a nitride ceramic, a conversion coating, and/or an aluminum intermetallic.

In another aspect, embodiments of the invention feature a solid oxide fuel cell device that includes, consists essentially of, or consists of a bottom endplate, a top endplate, one or more repeat units disposed between the top and bottom endplates, and a coating. Each repeat unit includes, consists essentially of, or consists of (i) a cell, (ii) a solid, electrically conductive interconnect plate for conducting electrical current from the cell, and (iii) disposed between the interconnect plate and the cell at least at a periphery of the repeat unit, a seal for reducing gas leakage from the repeat unit. The interconnect plate and the cell are electrically insulated from each other at the seal. The cell includes, consists essentially of, or consists of (i) a cathode, (ii) a solid ceramic electrolyte, and (iii) an anode for producing electricity through oxidation and reduction reactions involving a fuel and an oxygen source. The coating is disposed on the interconnect plate, the bottom endplate, and/or the top endplate. The coating includes, consists essentially of, or consists of graphite, copper, aluminum, a carbide ceramic, a nitride ceramic, a conversion coating, and/or an aluminum intermetallic.

Embodiments of the invention may include one or more of the following in any of a variety of combinations. The interconnect plate may include, consist essentially of, or consist of a terminal interconnect plate. The coating may include, consist essentially of, or consist of a cladding. The coating may include, consist essentially of, or consist of a plurality of layers. At least a first one of the layers may include, consist essentially of, or consist of a nitride ceramic. At least a second one of the layers may include, consist essentially of, or consist of a metal. The metal may include, consist essentially of, or consist of aluminum. The repeat units may be electrically connected in series. The seal may include, consist essentially of, or consist of graphite. The interconnect plate may include, consist essentially of, or consist of stainless steel and/or a nickel-based superalloy. The interconnect plate may include, consist essentially of, or consist of graphite, aluminum, and/or copper. The seal may include, consist essentially of, or consist of glass, one or more brazing alloys, talc, mica, vermiculite, asbestos, a ceramic material, and/or a polymer material. The interconnect plate may define a plurality of protruding contact features for electrically connecting the interconnect plate to the cell. An electrically conductive coating or cladding may be disposed over at least top surfaces of the contact features. The interconnect plate may define one or more flow channels for conduction of the fuel and/or of the oxygen source therethrough. An electrically conductive porous or mesh current collector may be disposed between and in contact with the cell and the interconnect plate.

An external seal may be disposed around the periphery of the repeat unit and may encapsulate the interconnect plate and/or the seal to reduce oxidation thereof. The device may include an electrically insulating first layer disposed between the seal and the interconnect plate, and/or an electrically insulating second layer disposed between the seal and the cell. The seal may include, consist essentially of, or consist of first and second layers. The first and second layers may include, consist essentially of, or consist of different materials. The first layer or the second layer may be electrically conductive. The device may include an electrically insulating first coating disposed on a first surface of the seal, and/or an electrically insulating second coating disposed on a second surface of the seal opposite the first surface. The top endplate and/or the bottom endplate may include, consist essentially of, or consist of graphite, aluminum, and/or copper. The one or more repeat units may be electrically connected to the top endplate and the bottom endplate. The one or more repeat units may not be electrically connected to the top endplate and the bottom endplate. The device may include a top terminal interconnect plate disposed between the top endplate and the plurality of repeat units. The top terminal interconnect plate may be electrically connected to the plurality of repeat units. The device may include a bottom terminal interconnect plate disposed between the bottom endplate and the plurality of repeat units. The bottom terminal interconnect plate may be electrically connected to the plurality of repeat units. A peripheral edge of the interconnect plate may be shaped to directly contact the cell of an adjacent repeat unit without a seal therebetween.

In yet another aspect, embodiments of the invention feature a solid oxide fuel cell device that includes, consists essentially of, or consists of a bottom endplate, a top endplate, a coating, and, disposed between the top and bottom endplates, (i) a cell having a top surface and a bottom surface opposite the top surface, (ii) a solid, electrically conductive first interconnect plate disposed over the top surface of the cell and electrically connected to the cell, (iii) a solid, electrically conductive second interconnect plate disposed below the bottom surface of the cell and electrically connected to the cell, (iv) a first seal disposed between the first interconnect plate and the cell at least at a periphery of the first interconnect plate, and (v) a second seal disposed between the second interconnect plate and the cell at least at a periphery of the second interconnect plate. The cell includes, consists essentially of, or consists of (i) a cathode, (ii) a solid ceramic electrolyte, and (iii) an anode for producing electricity through oxidation and reduction reactions involving a fuel and an oxygen source. The first interconnect plate and the cell are electrically insulated from each other at the first seal. The second interconnect plate and the cell are electrically insulated from each other at the second seal. The coating is disposed on the first interconnect plate, the second interconnect plate, the bottom endplate, and/or the top endplate. The coating includes, consists essentially of, or consists of graphite, copper, aluminum, a carbide ceramic, a nitride ceramic, a conversion coating, and/or an aluminum intermetallic.

Embodiments of the invention may include one or more of the following in any of a variety of combinations. The first interconnect plate and/or the second interconnect plate may include, consist essentially of, or consist of a terminal interconnect plate. The coating may include, consist essentially of, or consist of a cladding. The coating may include, consist essentially of, or consist of a plurality of layers. At least a first one of the layers may include, consist essentially of, or consist of a nitride ceramic. At least a second one of the layers may include, consist essentially of, or consist of a metal. The metal may include, consist essentially of, or consist of aluminum. A spacer may be disposed around a peripheral edge of the cell and between the first seal and the second seal. An external seal may be disposed around and may encapsulate an outer peripheral edge of the first interconnect plate, the second interconnect plate, the first seal, and/or the second seal. The device may include an electrically conductive porous or mesh first current collector disposed between and in contact with the cell and the first interconnect plate, and/or an electrically conductive porous or mesh second current collector disposed between and in contact with the cell and the second interconnect plate.

The device may include (i) an electrically insulating first layer disposed between the first seal and the first interconnect plate, (ii) an electrically insulating second layer disposed between the first seal and the cell, (iii) an electrically insulating third layer disposed between the second seal and the second interconnect plate, and/or (iv) an electrically insulating fourth layer disposed between the second seal and the cell. The first seal may include, consist essentially of, or consist of first and second layers. The first and second layers may include, consist essentially of, or consist of different materials. The second seal may include, consist essentially of, or consist of third and fourth layers. The third and fourth layers may include, consist essentially of, or consist of different materials. The first seal and/or the second seal may include, consist essentially of, or consist of graphite. The first interconnect plate and/or the second interconnect plate may include, consist essentially of, or consist of stainless steel and/or a nickel-based superalloy. The first interconnect plate and/or the second interconnect plate may include, consist essentially of, or consist of graphite, aluminum, and/or copper. The first seal and/or the second seal may include, consist essentially of, or consist of glass, one or more brazing alloys, talc, mica, vermiculite, asbestos, a ceramic material, and/or a polymer material.

In another aspect, embodiments of the invention feature a solid oxide fuel cell device that includes, consists essentially of, or consists of a bottom endplate, a top endplate, a coating, and, disposed between the top and bottom endplates, (i) a cell having a top surface and a bottom surface opposite the top surface, (ii) a solid, electrically conductive first interconnect plate disposed over the top surface of the cell and electrically connected to the cell, (iii) a solid, electrically conductive second interconnect plate disposed below the bottom surface of the cell and electrically connected to the cell, and (iv) a seal disposed between the second interconnect plate and the cell at least at a periphery of the second interconnect plate. The cell includes, consists essentially of, or consists of (i) a cathode, (ii) a solid ceramic electrolyte, and (iii) an anode for producing electricity through oxidation and reduction reactions involving a fuel and an oxygen source. A peripheral edge of the first interconnect plate is disposed in direct mechanical contact with the cell. The second interconnect plate and the cell are electrically insulated from each other at the seal. The coating is disposed on the first interconnect plate, the second interconnect plate, the bottom endplate, and/or the top endplate. The coating includes, consists essentially of, or consists of graphite, a carbide ceramic, a nitride ceramic, a conversion coating, and/or an aluminum intermetallic.

Embodiments of the invention may include one or more of the following in any of a variety of combinations. The first interconnect plate and/or the second interconnect plate may be a terminal interconnect plate. The coating may be a cladding. The coating may include, consist essentially of, or consist of a plurality of layers. At least a first one of the layers may include, consist essentially of, or consist of a nitride ceramic. At least a second one of the layers may include, consist essentially of, or consist of a metal. The metal may include, consist essentially of, or consist of aluminum. A spacer may be disposed around a peripheral edge of the cell and between the first interconnect plate and the seal. The device may include a first external seal disposed around and encapsulating an outer peripheral edge of the first interconnect plate, and/or a second external seal disposed around and encapsulating an outer peripheral edge of the second interconnect plate. The device may include an electrically conductive porous or mesh first current collector disposed between and in contact with the cell and the first interconnect plate, and/or an electrically conductive porous or mesh second current collector disposed between and in contact with the cell and the second interconnect plate. The device may include an electrically insulating first layer disposed between the seal and the second interconnect plate, and/or an electrically insulating second layer disposed between the seal and the cell. The seal may include, consist essentially of, or consist of first and second layers. The first and second layers may include, consist essentially of, or consist of different materials. The seal may include, consist essentially of, or consist of graphite. The first interconnect plate and/or the second interconnect plate may include, consist essentially of, or consist of stainless steel and/or a nickel-based superalloy. The first interconnect plate and/or the second interconnect plate may include, consist essentially of, or consist of graphite, aluminum, and/or copper. The seal may include, consist essentially of, or consist of glass, one or more brazing alloys, talc, mica, vermiculite, asbestos, a ceramic material, and/or a polymer material.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and may exist in various combinations and permutations. As used herein, the terms “approximately” and “substantially” mean ±10%, and in some embodiments, ±5%. The term “consists essentially of” means excluding other materials that contribute to function, unless otherwise defined herein. Nonetheless, such other materials may be present, collectively or individually, in trace amounts. For example, a structure consisting essentially of one or more metals will generally include only that metal (or those metals) and only unintentional impurities (which may be metallic or non-metallic) that may be detectable via chemical analysis but do not contribute to function.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic diagram of solid oxide fuel cell in accordance with various embodiments of the invention;

FIG. 2 is a schematic diagram of a portion of a solid oxide fuel cell device stack in accordance with various embodiments of the invention;

FIG. 3A is a schematic diagram of a solid oxide fuel cell device stack with endplates in accordance with various embodiments of the invention;

FIG. 3B is an exploded view of a repeat unit of the device stack of FIG. 3A in accordance with various embodiments of the invention;

FIGS. 3C and 3D schematically depict U-shaped and Z-shaped manifolding flow arrangements in accordance with various embodiments of the invention;

FIG. 3E is an exploded view of interconnects as they are arranged within a stack in an exemplary U-shaped manifolding flow arrangement in accordance with various embodiments of the invention;

FIG. 3F is an exploded view of a stack using direct manifolding with external fluidic connections made with side-plate manifolds in accordance with various embodiments of the invention;

FIG. 4A is a schematic perspective view of a repeat unit of a stack in which the cell and interconnect are approximately the same size in accordance with various embodiments of the invention;

FIG. 4B is a schematic cross-sectional view of the solid oxide fuel cell stack of FIG. 4A along line 4B-4B proximate the edges of the stacks, where the stack endplates are in electrical contact with one or more locations closer to the center of the stack in accordance with various embodiments of the invention;

FIG. 4C is a schematic cross-sectional view of the solid oxide fuel cell stack of FIG. 4A along line 4C-4C proximate the middle region of the stacks, where the stack endplates are in electrical contact with one or more locations closer to the center of the stack in accordance with various embodiments of the invention;

FIG. 4D is a schematic cross-sectional view of the solid oxide fuel cell stack of FIG. 4A along line 4B-4B proximate the edges of the stacks, where the stack endplates are electrically isolated from one or more locations closer to the center of the stack in accordance with various embodiments of the invention;

FIG. 4E is a schematic cross-sectional view of the solid oxide fuel cell stack of FIG. 4A along line 4C-4C proximate the middle region of the stacks, where the stack endplates are electrically isolated from one or more locations closer to the center of the stack in accordance with various embodiments of the invention;

FIG. 4F is a schematic perspective view of a repeat unit of a stack in which the cell is smaller than the interconnect;

FIG. 4G is a schematic cross-sectional view of the solid oxide fuel cell stack of FIG. 4F along line 4G-4G proximate the edges of the stacks in accordance with various embodiments of the invention (note that FIG. 4G is identical for embodiments in which the stack endplates are in electrical contact with or electrically isolated from one or more locations closer to the center of the stack);

FIG. 4H is a schematic cross-sectional view of the solid oxide fuel cell stack of FIG. 4F along line 4H-4H proximate the middle region of the stacks, where the stack endplates are in electrical contact with one or more locations closer to the center of the stack in accordance with various embodiments of the invention;

FIG. 41 is a schematic cross-sectional view of the solid oxide fuel cell stack of FIG. 4F along line 4H-4H proximate the middle region of the stacks, where the stack endplates are electrically isolated from one or more locations closer to the center of the stack and the cell is in direct electrical contact with interconnect contact ribs in accordance with various embodiments of the invention;

FIGS. 5A-5E are schematic cross-sections of seals for solid oxide fuel cell devices in accordance with various embodiments of the invention;

FIGS. 6A-6C are schematic cross-sections of solid oxide fuel cell device stacks proximate the edges of the stacks with external seals in accordance with various embodiments of the invention;

FIG. 7A is a schematic perspective view of an interconnect for a solid oxide fuel cell device in accordance with various embodiments of the invention;

FIG. 7B is a schematic cross-sectional view of the interconnect of FIG. 7A along line 7B-7B;

FIGS. 8A and 8B are schematic cross-sectional views of components for a solid oxide fuel cell device with insulating layers in accordance with various embodiments of the invention;

FIGS. 9-11 are schematic cross-sections of portions of solid oxide fuel cell device stacks proximate the centers of the stacks in accordance with various embodiments of the invention;

FIG. 12 is a plot showing the degree of fuel leakage for different gasket materials as a function of temperature and back-pressure using the flow-through (FT) leak characterization setup from the second test example;

FIG. 13 is a plot showing the degree of cross-over leakage from anode-to-cathode and cathode-to-anode for the hybrid graphite/vermiculite (anode) and vermiculite (cathode) seal configuration of the third test example;

FIG. 14 is a plot showing the degree of cross-over leakage from anode-to-cathode and cathode-to-anode for the symmetric vermiculite (anode) and vermiculite (cathode) seal configuration of the fourth test example;

FIG. 15 is a plot showing the anode-to-cathode cross-over percentage as a function of time for the symmetric graphite (anode) and graphite (cathode) seal configuration of the fifth test example.

FIG. 16 is a plot showing the cathode-to-anode cross-over percentage as a function of time for the symmetric graphite (anode) and graphite (cathode) seal configuration of the fifth test example.

FIGS. 17A-17C are plots that summarize the cross-over leakage results for the asymmetric graphite (anode) and vermiculite (cathode) seal configuration of the sixth test example;

FIG. 18 is a plot of the area specific resistance for TiN on AL6061 as a function of time for a sample held at 500° C. for 12 hours;

FIG. 19A and 19B are SEM micrographs depicting a TiN coating on a stainless steel test coupon before and after area specific resistance (ASR) measurements at 500° C. from the eighth test;

FIG. 20 is a plot showing the voltage and power density as a function of current density for a Ni-cermet/GDC electrolyte SOFC assembled with TiN-coated aluminum interconnects and operated between 475° C. and 550° C. in the eleventh test; and

FIG. 21 is a plot showing the long-term performance for a Ni-cermet SOFC assembled with TiN-coated aluminum interconnects and operated at 515° C. and held at constant current in the eleventh test.

### DETAILED DESCRIPTION

FIG. 1 schematically depicts an SOFC cell 100 in accordance with embodiments of the present invention for illustration of its theory of operation. As shown, the SOFC cell 100 features a cathode 110, a solid electrolyte 120, and an anode 130. As shown, the anode 130 may include, consist essentially of, or consist of an anode support (or anode support layer) 135 and an anode functional layer (AFL) 140. The cathode 110 may also include, consist essentially of, or consist of a cathode layer 111 and a cathode functional layer (CFL) 112. During operation of SOFC cell 100, oxygen from an oxygen source 150 (e.g., air) is ionized by the cathode 110. The resulting oxygen ions are conducted from the cathode 110, through the solid electrolyte 120, to the anode 130. At the anode 130, the oxygen ions are reacted with a fuel 160 (which is typically gaseous) to produce electricity. As shown, the generated electricity may be flowed through an external load 170 and back to the cathode 110 to support further ionization at the cathode 110. The electrochemical reaction may also generate by-products such as, e.g., water and carbon dioxide at the anode 130. The fuel 160 may include, consist essentially of, or consist of, for example, hydrogen gas and/or a hydrocarbon fuel such as natural gas, propane, gasoline, diesel, or biofuel, or a hydrogen-containing fuel (e.g., ammonia, or NH₃), or a carbon-containing fuel such as carbon monoxide. In various embodiments, the fuel 160 may include, consist essentially of, or consist of a mixture of H₂, CO, H₂O, CO₂, and CH₄ (e.g., a synthetic gas or syngas). For increased power generation, multiple SOFC cells 100 may be linked together in a stacked structure, as detailed below. While FIG. 1 depicts cell 100 in a planar configuration, in various embodiments of the invention the SOFC cell may be arranged in a concentric tubular configuration, or some similar variation thereof. Moreover, while FIG. 1 depicts the cross-section of cell 100 as a square, in various embodiments of the invention the planar cell may have a different shape (e.g., a rectangle or a circle). Similarly, a tubular cell may have different shapes (e.g., a circular tube or a tube with more of an oval shape that has both round and flat surfaces). For example, the oxygen source 150 may be flowed through a tubular cathode 110, around which are disposed tubular electrolyte 120 and anode 130, while the fuel 160 may be flowed around the outside of the anode 130. Alternatively, fuel 160 may be flowed through a tubular anode 130, around which are disposed tubular electrolyte 120 and cathode 110, while the oxygen source 150 is flowed around the outside of SOFC 100.

In various embodiments of the invention, the cathode 110 includes, consists essentially of, or consists of, for example, one or more of the following materials: lanthanum manganites such as lanthanum strontium manganite (LSM, e.g, La₁₋ₓSrₓMnO_{3-δ}) and lanthanum calcium manganite (LCM, e.g., La₁₋ₓCaₓMnO_{3-δ}); manganites such as Ln₁₋ₓSrₓMnO_{3-δ}(Ln=La, Pr, Nd, Sm, Gd, Yb, or Y; and); cobaltites such as Ln₁₋ₓSrₓCoO_{3-δ}(Ln=La, Pr, Nd, Sm, or Gd), lanthanum strontium cobaltite (LSC, e.g., La₁₋ₓSrₓCo_{3-δ}), samarium strontium cobaltite (SSC, e.g., Sm_{0.5}Sr_{0.5}CoO_{3-δ}), and strontium cerium cobaltite (SCC, e.g. Sr_{0.9}Ce_{0.1}Co)_{3-δ}); ferrites such as lanthanum ferrite (e.g., LaFeO₃), Sr-doped lanthanum ferrite (e.g., La_{0.8}Sr_{0.2}FeO₃), lanthanum strontium cobalt ferrite (LSCF, e.g., La_{0.6}Sr_{0.4}Co_{0.8}Fe_{0.2}O_{3-δ}), praseodymium strontium cobalt ferrite (PSCF, e.g., Pr₁₋ₓSrₓCo_{0.8}Fe_{0.2}O_{3-δ}), and barium strontium cobalt ferrite (BSCF, e.g., Ba_{0.5}Sr_{0.5}Co_{0.8}Fe_{0.2}O_{3-δ}); nickelates such as iron-doped nickelate (LNF, e.g., LaFe₁₋ₓNiₓO_{3-δ}) and Sr-doped LNF (LSNF); and cathode materials with the K₂NiF₄ type structure such as La₂BO₄ (B═Co, Ni, Cu), alkaline- (e.g., Sr, Ba, Ca) and rare earth (e.g., Nd or Pr) doping at the La site such as La₂Ni₁₋ₓCoO_{4+δ}, and transition metal (e.g., Cu or Co) doping at the Ni site. Cathode materials may be pure electronic conductors, or they may be mixed ionic electronic conductors (MIECs) in which the electronic conductor may be an electron or hole.

In general, the solid electrolyte 120 is a dense ceramic material that conducts oxygen ions while minimizing electronic conduction therewithin in order to prevent current leakage and corresponding electrical losses. However, a solid electrolyte 120 may also conduct protons (i.e., H⁺ ions) or other types of ions (e.g., Na⁺ ion conductors such as Na₃Zr₂Si₂PO₁₂, or NASICON). Electrolyte 120 materials may be pure ion conductors, or they may be MIECs. The electrolyte may include, consist essentially of, or consist of multiple layers of different electrolyte materials (e.g., two different oxygen ion conductor layers, or an oxygen ion conductor layer and proton conductor layer). The thickness of the solid electrolyte 120 may range from, for example, approximately 500 nm to approximately 40 μm, or 1 μm to approximately 40 μm, or 5 μm to approximately 30 μm, or even from approximately 10 μm to approximately 30 μm.

In various embodiments of the invention, the electrolyte 120 includes, consists essentially of, or consists of, for example, one or more of the following oxygen ion conducting materials: zirconia-based solid electrolytes such as zirconia stabilized with one or more of alkaline or rare earth dopants such as Y, Sc, Ce, Ca, Mg, or Al (e.g., Zr₁₋ₓYₓO_{2-x/2} and Zr₁₋ₓScₓO_{2-x/2}); ceria electrolytes doped with one or more alkaline or rare earth dopants such as Y, Yb, Sc, Ca, Mg, Zr, Gd, Sm Y, La, Pr, Sm, Nd, Ba, or Sr (e.g., Ce₁₋ₓMₓO_{2-δ}, M=Gd or Sm, x=0.1-0.2); LaGaO₃-based electrolytes such as lanthanum strontium gallium magnesium oxide (LSGM, e.g., La₁₋ₓSrₓGa_{1-y}Mg_{y}O_{3-δ}); bismuth oxide-based materials (e.g., Bi_{0.8}Er_{0.2}O_{1.5}, Bi₂Sr₂Nb₂GaO_{11.5}, Bi_{0.88}Dy_{0.08}W_{0.04}O_{1.5} and Bi₂V_{0.9}Cu_{0.1}O_{5.5-δ}); perovskites based on LnBO₃ (B═Al, In, Sc, Y); pyrochlores and fluorite-type materials (Y,Nb,Zr)O_{2-δ}; materials based on La₂Mo₂O₉ (LAMOX , e.g., La₂Mo₂O₉, La_{1.7}Bi_{0.3}Mo₂O₉, and La₂Mo_{1.7}W_{0.3}O₉; perovskite- and brownmillerite-like phases derived from Ba₂In₂O (e.g., Ba₂In₂O₅; apatite-type phases A₁₀₋ₓ(MO₄)₆O_{2-δ} where M=Si or Ge, and A corresponds to rare earth and alkaline earth cations (e.g., Ln₁₀Si₆O₂₇ where Ln=La, Pr, Nd, Sm, Gd, or Dy).

In various embodiments of the invention, the electrolyte 120 includes, consists essentially of, or consists of, for example, one or more of the following proton conducting materials: BaCeO₃ and BaZrO₃ and varieties that are 1) doped with one or more of with one or more of Y, Sc, Nd, Gd, Yb, etc. (e.g., BaₓCe_{0.9}Y_{0.1}O_{3-δ}(BCY), BaZr_{0.8}Y_{0.2}O_{3-δ} (BZY) or BaCe_{0.7}Zr_{0.2}Y_{0.2}O_{3-δ} (BCZY)); 2) doped with one or more of Y, Sc, Nd, Gd, and Yb and one of F, Cl, or Br halogens (e.g., 5 mol % F-doped BaCe_{0.90}Gd_{0.1}O_{3-δ}, or BCGF; and 5-mol % Cl doped BaCe_{0.90}Gd_{0.1}O_{3-δ}, or BCGCl); 3) doped with one or more of transition metals such as Y, Ti, Zr, Mo, Fe, or Co and post-transition metals such as Ga, In, or Sn (e.g., BaCo_{0.4}Fe_{0.4}Zr_{0.2}O_{3-δ} (BCFZ), BaCo_{0.4}Fe_{0.4}Zr_{0.1}Y_{0.1}O_{3-δ} (BCFZY)); or 4) co-doped with donor dopants such as Nb or Ta (e.g., Ba₁₋ₓNdₓCe_{1-y}Nd_{y}O_{3-(y-x)/2}).

In various embodiments of the invention, the solid electrolyte 120 includes, consists essentially of, or consists of, for example, various doped ceria materials such as samarium doped ceria (SDC, e.g., Ce_{0.8}Sm_{0.2}O_{1.9}) or gadolinium doped ceria (GDC, e.g., Ce_{0.9}Gd_{0.1}O_{1.95}). Such solid electrolytes 120 may have dopant concentrations ranging from, for example, approximately 5 to approximately 30 mol %, or from approximately 10 to approximately 20 mol %. In various embodiments, the solid electrolyte 120 may include, consist essentially of, or consist of one or more doped cerias such as yttria-doped ceria (YDC, e.g., Y_{0.1}Ce_{0.9}O_{1.95}), neodymium-doped ceria (NdDC, e.g., Nd_{0.1}Ce_{0.9}O_{1.95}), praseodymium-doped ceria (PrDC, e.g., Pr_{0.1}Ce_{0.9}O_{1.95}), and/or lanthanum-doped ceria (LaDC, e.g., La_{0.1}Ce_{0.9}O_{1.95}). Such solid electrolytes 120 may have dopant concentrations ranging from, for example, approximately 5 to approximately 30 mol %, or from approximately 10 to approximately 20 mol %.

The cathode 110 may include, consist essentially of, or consist of a composite material of one or more cathode materials and one or more electrolyte 120 materials. For example, the cathode 110 may include, consist essentially of, or consist of a mixture of LSCF and GDC or SSC and GDC, e.g., in a ratio of approximately 3:7 to approximately 7:3 by mass. The cathode 110 composite material may be both an ionic conductor and an electronic conductor, and the cathode 110 may be porous to promote oxygen access for ionization and to provide electrochemically active triple phase boundaries (TPBs) where the electrolyte 120, air, and cathode 110 meet. For example, the cathode 110 may have a porosity ranging from approximately 30% to approximately 60%, or from approximately 35% to approximately 55%, or even from approximately 40% to approximately 30%. In various embodiments, the thickness of the cathode 110 may be approximately 0.5 μm to approximately 500 μm, or approximately 5μm to approximately 250 μm, or even approximately 10 μm to approximately 100 μm.

Between the cathode layer 111 and the electrolyte 120 there may reside a cathode functional layer (CFL) 112. The CFL 112 may act to reduce the interfacial resistances between the cathode layer 111 and electrolyte 120 and/or to prevent undesirable reactions between the cathode layer 111 and electrolyte 120 that may occur during SOFC fabrication or operation. Such CFLs 112 are generally fairly thin and may be approximately 1 nm to approximately 20 μm thick. The thickness of the CFL 112 may also be between approximately 500 nm and approximately 10 μm or even between approximately 1 and approximately 5 μm. A CFL 112 may include, consist essentially of, or consist of any combination of the materials described herein for the cathode (e.g, LSCF) and/or electrolyte layers (e.g., GDC), or less complex compounds featuring elements within such materials (e.g., cobalt or cobalt oxide). A CFL 112 may also include, consist essentially of, or consist of a single cathode layer 111 or electrolyte 120 material.

Like the cathode 110, the anode 130 may be a composite material, and is preferably a porous, ionic and electronic (i.e., electrons and/or holes) conductor in order to promote the electrochemical reaction. In various embodiments of the invention, the anode 130 includes, consists essentially of, or consists of a single phase or a composite material as a mixture, e.g., in a ratio of approximately 3:7 to approximately 7:3 by mass for a two-phase composite. In various embodiments, any phase or all phases of anode 130 may include, consist essentially of, or consist of, a MIEC material. In various embodiments, any phase or all phases of anode 130 may include, consist essentially of, or consist of, a pure electronic conductor or ionic conductor. In various embodiments of the invention, the anode 130 is a composite that includes, consists essentially of, or consists of cermet material. In various embodiments of the invention, the anode 130 is a cermet that includes, consists essentially of, or consists of, for example, various transition metals (e.g., Ni, Cu, Ti, Co, Mn, V, Mo, Nb, W, and/or Fe) mixed together as a composite with one or more solid electrolyte 120 materials. For example, the ceramic component of the composite cermet anode 130 may include, consist essentially of, or consist of yttria stabilized zirconia (YSZ). The YSZ in the composite cermet anode 130 may have dopant concentrations ranging from, for example, approximately 2 to approximately 20 mol %, or from approximately 3 to approximately 12 mol %. In various embodiments, the YSZ includes 8 mol % Y (8YSZ, e.g., (ZrN_{0.92}(Y₂O₃)_{0.08}) and/or 3 mol % Y (3YSZ, e.g., (ZrO₂)_{0.97}(Y₂O₃)_{0.03}). In various embodiments of the invention, the anode 130 includes, consists essentially of, or consists of, for example, a composite of Ni and YSZ (Ni—YSZ) or a composite of Cu and YSZ (Cu—YSZ). In various other embodiments of the invention, the ceramic component of a composite cermet anode 130 includes, consists essentially of, or consists of, for example, GDC. In various embodiments of the invention, the anode 130 includes, consists essentially of, or consists of, for example, a composite of Ni and GDC (Ni-GDC) or a composite of Cu and GDC (Cu-GDC). Transition metal components in an anode 130 cermet may exist as a ceramic (e.g., an oxide such as NiO) in an as-fabricated SOFC cell 100 but transform into a metallic phase (e.g., Ni metal) in a reducing environment (e.g., a gas environment containing hydrogen gas).

In various embodiments of the invention, all or a portion of the anode 130 includes, consists essentially of, or consists of, for example, one or more of the following electronically conductive or MIEC ceramic materials: titanate-based oxides such as lanthanum strontium titanates (LST, e.g., La_{0.4}Sr_{0.6}TiO₃), Fe-doped calcium titanates (e.g., CaFeₓTi₁₋ₓO_{3-δ}), titania-doped YSZ, Sc- and Y-doped titanium zirconate (e.g., Sc_{0.15}Y_{0.05}Zr_{0.62}Ti_{0.18}O_{1.9}); lanthanum chromites (e.g., (La,Sr)CrO₃) and (LaA)(CrB)O₃ system (A=Ca, Sr and B═Mg, Mn, Fe, Co, Ni); ceramic oxides including ceramic oxide materials containing strontium, iron, cobalt, and molybdenum (i.e., SFCM, e.g., SrFe_{0.1}Co_{0.45}Mo_{0.45}O₃, SrFe_{0.2}Co_{0.4}Mo_{0.4}O₃, SrFe_{0.34}Co_{0.33}Mo_{0.33}O₃, or SrFe_{0.5}Co_{0.25}Mo_{0.25}O₃), SrFeCo₃Oₓ, SrCo_{0.8}Fe_{0.2}O₃, and La_{0.6}Sr_{0.4}Fe_{0.8}Co_{0.2}O₃ (LSCF). In various embodiments of the invention, the electronically conductive or MIEC ceramic materials are mixed with one or more solid electrolyte 120 materials as a composite anode 130.

All or a portion of the anode 130 may include, consist essentially of, or consist of a mixture of SFCM and another material such as ceria or GDC. For example, as shown in FIG. 1, the anode 130 may be composed of an anode support 135 and an anode functional layer 140. The anode support 135, which supports the cell 100 and allows gas (i.e., fuel) access to the functional layer 140, may include, consist essentially of, or consist of, e.g., a mixture of SFCM and ceria. The anode functional layer 140, which promotes electrocatalytic activity in the anode 130, may include, consist essentially of, or consist of, e.g., a mixture of SFCM and GDC. In various embodiments, the anode 130 is free of nickel, nickel oxide, and/or yttria. In accordance with embodiments of the invention, the anode 130 and/or portions thereof (e.g., anode support 135 and/or anode functional layer 140) may be “all-ceramic,” i.e., free of nickel, nickel oxide, and other metals not incorporated within a ceramic-phase network. Such materials may exhibit superior performance and reliability during load following, thermal cycling, and redox cycling.

In various embodiments of the invention, the anode 130 is further modified with the addition of one or more alkaline- and rare-earth materials (e.g., MgO, CaO, SrO and CeO₂) as an additional phase within the cermet or ceramic material. Other materials may “decorate” the surface of the anode 130 and may be deposited via various techniques, such as an infiltrate solution (e.g., nickel or cerium nitrate) followed by calcination. Other deposition methods of the surface “decorating” materials include wash coating (e.g., a colloidal solution) and chemical vapor deposition (CVD). The addition of such materials to the surface of the anode (including the surface of pores and interfaces within the anode) may enhance ionic and/or electronic conductivity, may enhance catalytic and/or electrocatalytic activity, and/or may suppress undesirable reactions such as sulfur poisoning or coking in the presence of certain fuel compositions (e.g., natural gas). Additional infiltrate materials for anode 130 include, consist essentially of, or consist of, for example, platinum group metals (e.g., Pt or Ru) and/or constituents from any of the other possible combinations of materials of the anode 130 (e.g., Ni, Ce, Gd, Cu, Mg, Co, Pr, etc.).

In various embodiments of the invention, the anode 130 may include, consist essentially of, or consist of an anode support (or anode support layer) 135 and an anode functional layer (AFL) 140. The AFL may include, consist essentially of, or consist of finer particles than in the ASL, thereby providing a higher number of triple phase boundaries and subsequent higher electrochemical activity. The AFL may act to reduce the interfacial resistances between the anode and electrolyte and/or to prevent undesirable reactions between the anode support layer 135 and electrolyte 120 that may occur during SOFC fabrication or operation. Such AFLs 140 are generally fairly thin and in various embodiments AFL 140 may be approximately 1 nm to approximately 20 μm thick. In various embodiments, the thickness of AFL 140 may be between approximately 500 nm and approximately 10 μm or even between approximately 1 and approximately 5 μm. An AFL 140 may include, consist essentially of, or consist of any combination of the materials of the anode and/or electrolyte layers (e.g., Ni-GDC), or less complex compounds featuring elements within such materials (e.g., cobalt or cobalt oxide). The thickness of an anode support layer (ASL) 135 may be approximately 100 μm to approximately 2,000 μm thick, or approximately 150 μm to approximately 1,000 μm, or approximately 200 μm to approximately 800 μm, or even approximately 350 μm to approximately 700 μm thick.

In various embodiments, the cell 100 is electrolyte supported. Referring to FIG. 1, the electrolyte 120 is the thickest part of an electrolyte-supported cell 100. The anode 130 and cathode 110 are much thinner than the electrolyte 120 in a cell 100 that is electrolyte supported. While such cells tend to be stronger because the dense electrolyte is the thickest part of the cell, among other advantages, they tend to have greater ohmic losses and therefore the tradeoff is lower performance compared to electrode-supported (e.g., anode-supported) cells. For a cell 100 that is electrolyte-supported, the thickness of an electrolyte support layer may be approximately 75 μm to approximately 750 μm thick, or approximately 125 μm to approximately 500 μm, or even approximately 200 μm to approximately 350 μm thick. The electrolyte support layer in an electrolyte-supported cell may be thinner than an anode support layer in an anode-supported cell, e.g., due to the high density of typical electrolytes, whereas anodes are porous. For an electrolyte-supported cell 100, the anode 130 may have a thickness of approximately 5 μm to approximately 200 μm, or approximately 10 μm to approximately 100 μm, or even approximately 15 μm to approximately 50 μm. The cathode 110 for an electrolyte-supported cell 100 may have a thickness of approximately 0.5 μm to approximately 500 μm thick, or approximately 5μm to approximately 250 μm, or even approximately 10 μm to approximately 100 μm thick.

In various embodiments, the cell 100 is cathode supported. Referring to FIG. 1, the cathode 110 is the thickest part of a cathode-supported cell 100. The anode 130 and electrolyte 120 are much thinner than the cathode 110 in a cell 100 that is cathode-supported. While cathode-supported cells have been shown to have long lifetimes with low degradation, the tradeoff is that they tend to be more difficult to manufacture than electrolyte-supported cells or anode-supported cells, and they tend to have lower performance than anode-supported cells. For a cell 100 that is cathode-supported, the thickness of a cathode support layer may be approximately 125 μm to approximately 1,000 μm thick, or approximately 250 μm to approximately 800 μm, or even approximately 400 μm to approximately 600 μm thick. For a cathode-supported cell 100, the anode 130 may have a thickness of approximately 5 μm to approximately 200 μm, or approximately 10 μm to approximately 100 μm, or even approximately 15 μm to approximately 50 μm. For a cathode-supported cell 100, the electrolyte 110 may have a thickness that ranges from, for example, approximately 500 nm to approximately 40 μm, or 1 μm to approximately 40 μm, or 5 μm to approximately 30 μm, or even from approximately 10 μm to approximately 30 μm.

In various embodiments, the cell 100 is metal supported or even ceramic supported. For instance, a metal-supported cell 100 may include, consist essentially of, or consist of a metal support (e.g., a porous stainless steel such as 441 stainless steel) on which a thinner anode material (e.g., a cermet such as Ni—YSZ), electrolyte, and cathode are disposed. The thinner layers in such cells are often deposited using thin-film deposition techniques (e.g., sputtering or thermal/plasma spray techniques) to avoid undesirable reactions between the support and the other layers at high temperatures. A ceramic-supported cell may include a porous ceramic support (e.g., a YSZ or GDC scaffold), on which a thinner anode material (e.g., a cermet such as Ni—YSZ), electrolyte, and cathode are disposed. While supporting the cell, the porous ceramic support does not function as an anode. The porous ceramic support may be an electronically-conductive ceramic, or electronic conductivity may be introduced through infiltration of a conductive material (e.g., nickel) that coats all or a portion of the scaffold. In various embodiments, an interconnect is used as the cell support, such that a separate interconnect is not needed in the SOFC stack. In various embodiments, a porous metal-supported cell 100 or ceramic-supported cell 100 is joined to an interconnect (e.g., using brazing or welding). In various embodiments, the metal, ceramic, or interconnect support may have a thickness of approximately 100 μm to approximately 5,000 μm, or approximately 150 μm to approximately 1,000 μm, or even approximately 200 μm to approximately 500

As mentioned above, multiple SOFC cells may be utilized in an SOFC in a stacked, series-connected configuration in order to, for example, increase the operating voltage of the SOFC. FIG. 2 is a schematic depiction of a portion of such a series-connected stack configuration, in which each cell 100 is separated from neighboring cells 100 by a solid interconnect plate (or “interconnect”) 200. While examples herein demonstrate a flat plate interconnect, the interconnect may also be made into other shapes to accommodate interconnection of multiple, non-planar cells (e.g., tubular, or partially tubular, or concave shapes; or even strips of material deposited onto the tubular cell surface). In various embodiments, an interconnect may have different shapes, including plates, tubes, or partial tubes. In various embodiments, an interconnect (or interconnect braze material) may be deposited directly on the cell, conforming to the shape of the cell or to the shape of a portion of the cell.

The interconnect 200 is typically electrically conductive in order to enable flow of electronic (as opposed to ionic) current (or “current”) 210 between cells 100 and eventually out of the SOFC stack itself to an external electrical load. As shown, the interconnects 200 may be shaped to facilitate separation and uniformity of the flows of the oxygen source 150 and the fuel 160, e.g., with ribs and channels that may extend in different directions across the interconnect 200. In various embodiments, the ribs and channels may define different shapes in interconnect 200, such as herringbone or serpentine patterns. Such patterns may be continuous or discontinuous along the interconnect 200. In various embodiments the pattern is the same on both sides of the interconnect 200. In various embodiments the pattern on one side of the interconnect 200 is different than the pattern on the other side of interconnect 200. Interconnects 200 may even, in various embodiments, define other features such as gas plenums, and/or flow-field vanes to, in part, direct the gas flow. Such other features of interconnect 200 may be of the same or similar design as described for the ribs and channels. As indicated by the inclusion of the partial cathode 110 above the top interconnect 200 and the partial anode 130 below the bottom interconnect 200 in FIG. 2, an SOFC in accordance with embodiments of the invention may incorporate multiple cells 100 separated by interconnects 200. Although FIG. 2 and FIG. 1 show the cathode 110, anode 130, and electrolyte 120 as having the same length and width dimensions, each layer in cell 100 may have different length and width dimensions.

FIG. 2 shows a reactant flow configuration known as cross-flow, in which the oxygen source 150 and the fuel 160 flow in directions perpendicular to each other. In various embodiments, the SOFC stack may utilize or also utilize flow arrangements in which oxygen source 150 and fuel 160 flow in parallel to each other. For example, the SOFC stack may use a co-flow configuration (i.e., parallel flow paths in the same direction) or a counter-flow configuration (i.e., parallel flow paths in opposite directions).

In various embodiments, the cells in an SOFC stack are connected in different configurations of series and parallel connections to achieve, for example, various mechanical and/or electrical design specifications. For example, an SOFC stack may include two parallel-connected sets of cells, where each set of cells includes multiple (e.g., ten) series-connected cells in order to achieve a particular voltage output range at a specified rated power level for the stack. In various embodiments, multiple different SOFC stacks may be connected electrically in series or parallel, while still existing as separate mechanical assemblies. In various embodiments, certain cells within an SOFC stack are stacked along the axis of the SOFC stack as a mechanical assembly while remaining electrically isolated as a whole (i.e., certain regions of the stack are electrically isolated from other regions of the stack).

In various embodiments, the interconnects 200 may include, consist essentially of, or consist of one or more materials such as stainless steel (e.g., a 400-series stainless steel such as 440, 441, or 430 stainless steel, or a 300-series stainless steel such as 304 or 316 stainless steel, or specialty stainless steels such as Crofer 22 APU or Crofer 22 H), a high-temperature Ni-based alloy such as a Hastelloy (e.g., an alloy including, consisting essentially of, or consisting of Ni with one or more of Co, Cr, Mo, Fe, Si, C, Mn, V, Ti, or W), an Inconel (e.g., a Ni-Cr-based superalloy also containing one or more of Fe, Mo, Nb, Ta, Co, Mn, Cu, Al, Ti, Si, C, S, P, or B), or a Monel (e.g., a Ni—Cu alloy also containing one or more of Fe, Mn, C, or Si), graphite, aluminum, or copper. In various embodiments, all of the interconnects 200 in the SOFC may include, consist essentially of, or consist of the same material, while in other embodiments, at least two of the interconnects 200 include, consist essentially of, or consist of different materials. In various embodiments, the interconnects 200 include, consist essentially of, or consist of one or more aluminum alloys (e.g., 6061, 2024, 3003, 7075, or 5000-series aluminum alloys) or alloys of aluminum with one or more of Si, Cu, Ni, or Fe. In various embodiments, the overall thickness (e.g., maximum thickness) of an interconnect 200 may range from, for example, approximately 0.2 mm to approximately 30 mm, or 0.2 mm to 10 mm, or even 0.5 mm to 4 mm. In various embodiments, the minimum web thickness (i.e., the minimum thickness anywhere on the part) of an interconnect 200 may range from approximately 0.02 mm to approximately 0.5 mm. In various embodiments, the minimum web thickness of an interconnect 200 may range from approximately 0.05 mm to approximately 0.3 mm, or even approximately 0.1 mm to approximately 0.2 mm. Interconnects 200 may be fabricated utilizing conventional processes, or combinations of these processes, such as machining (e.g., milling), stamping, laser cutting, chemical etching, hydroforming, waterj et cutting, casting, pressing, injection molding, etc.

FIG. 3A schematically depicts an SOFC 300 featuring multiple cells 100 and interconnects 200 electrically connected in series. As shown in FIG. 3B, the SOFC 300 is therefore partially composed of multiple “repeat units” 310. SOFCs in accordance with embodiments of the invention may feature two or more, 10 or more, 50 or more, or even 100 or more repeat units 310, depending upon the desired voltage and output power for the SOFC 300 stack. While shown as a square plate, the interconnect plate may have any other shape (e.g., circle, rectangle, or oval) to accommodate cell geometries or other constraints. As shown, each repeat unit 310 may include, consist essentially of, or consist of a cell 100, an interconnect 200, and one or more seals (or “gaskets”) 320 disposed between the cell 100 and adjoining interconnects 200. The seals 320 seal the SOFC 300 and prevent or minimize external leaks and/or cross-over leaks between different components of the SOFC 300. For example, the seals 320 may substantially prevent cross-over leakage between the interconnect channels for the oxygen source and the interconnect channels for the fuel (see, e.g., FIG. 2). Although the seals 320 are schematically depicted as frames substantially conforming to the shape of the edges of the SOFC 300 stack, in various embodiments one or more of the seals may cover more of the area of the cell 100 and/or the interconnect 200, and may define multiple openings or apertures therethrough. Seals 320 may be formed via conventional processes such as casting (e.g., slip casting or tape casting), extrusion, 3D printing, screen printing, laser cutting, die cutting, blade cutting, water jet cutting, machining (e.g., milling), etc. Seals 320 may be formed/shaped in a single step (e.g., screen-printed seals) or initially formed and then shaped (e.g., tape casting followed by die cut). Seals 320 may also be formed/shaped in place (e.g., 3D printed), or formed/shaped first followed by assembly with the remainder of the components in SOFC 300 stack (e.g., use of pre-cut gaskets). Additional deposition techniques for formed/shaped-in-place seals 320 include spray coating and various physical and chemical vapor deposition techniques (e.g., sputtering, pulsed laser deposition, or evaporation). Seals 320 may also be effectively made as a result of joining components using brazing, welding, etc.

In various embodiments of the invention, each repeat unit may feature one or more seals 320 on only one side of the cell 100, such seals situated on either the anode 130 side or cathode 110 side of the cell. In various embodiments, each repeat unit may feature one or more seals 320 on both sides of the cell 100, where the seals 320 on the cathode 110 side of the cell have the same geometry, quantity, configuration, and are composed of the same materials as the seals 320 on the anode 130 side of the cell (i.e., the repeat unit has a completely symmetric seal arrangement). In various embodiments, each repeat unit may feature one or more seals 320 on both sides of the cell 100, where the seals 320 on the cathode 110 side of the cell are different than the seals 320 on the anode 130 side of the cell (i.e., the repeat unit has an asymmetric seal arrangement). In various embodiments, the difference between the seals 320 on either side of the cell 100 is a difference in one or more of the materials, geometry, or quantity of seals 320. In various embodiments, the thickness of the seals 320 on the cathode 110 side of the cell 100 is different than the thickness of the seals 320 on the anode 130 side of the cell.

Exemplary symmetric seal arrangements in accordance with embodiments of the invention include vermiculite seals on both the anode and cathode sides of the cell, as well as graphite seals on both the anode and cathode sides of the cell. (Note that symmetric seal arrangements include those in which glass may be disposed (e.g., printed) on the edge of one or more seals, as opposed to, for example, being uniformly applied on the seals themselves.) Exemplary asymmetric seal arrangements in accordance with embodiments of the invention include graphite seals on the anode side and vermiculite seals on the cathode side of the cell.

In various embodiments of the invention, the seals 320 may include, consist essentially of, or consist of graphite. In embodiments in which one or more interconnects 200 include, consist essentially of, or consist of graphite, one or more seals 320 (e.g., one or more seals 320 that would otherwise separate the interconnect 200 from an adjoining cell 100) may be omitted, and the interconnect 200 may also function as a seal in the SOFC stack. In various embodiments, one or more of the seals 320 may include, consist essentially of, or consist of one or more other materials such as mica, vermiculite, glass, brazing alloys, asbestos, polyamides (e.g., aramid), talc, polyimides (e.g., Kapton), polyamide-imides (e.g., Torlon), polysiloxanes (e.g., silicone), and/or silsesquioxanes (e.g., phenyl silsesquioxane). In various embodiments, a polysiloxane seal 320 is a room-temperature-vulcanizing (RTV) silicone (e.g., Copper RTV available from Permatex of Hartford, Conn.). In various embodiments, at least one seal 320 includes, consists essentially of, or consists of one or more brazing alloys (e.g., Ag—Cu—Ti brazes including Ag_{70.5}Cu_{26.5}Ti₃ and Ag₆₄Cu_{34.2}Ti_{1.8}; and silver-based brazes including Ag₁₀₀, Ag₇₂Cu₂₈, Ag₇₀Cu₂₀Zn₁₀, and Ag₆₀Cu₂₅Zn₁₅). In various embodiments, at least one seal 320 includes, consists essentially of, or consists of brazing alloys that may include, consist essentially of, or consist of aluminum and/or copper (e.g., Al—Si and Al—Si—Cu brazes including Al_{94.75}Si_{5.25}, Al_{92.5}Si_{7.5}Al₉₀S₁₀, and Al₈₆Si₁₀Cu₄; and Cu-based brazes including Cu₈₅Sn₈Ag₇, Cu_{75.5}Ag₁₈P_{6.5}, and Cu_{92.8}P_{7.2}). Note, these example brazing alloys are described in terms of the nominal composition and are available from a number of manufacturers under different brands/product names, including Lucas Milhaupt (e.g., SILVALOY), Prince & Izant Company (e.g., BAlSi), and SAXONIA Technical Materials (e.g., BrazeTec). Brazing alloys may be utilized in different forms, including paste, foil, wire, strip, or powder. While not necessary in each instance, in certain cases a flux (e.g., salts containing fluorine and/or boron) may be used with the brazing alloy to, for instance, prevent oxidation and improve wetting during brazing operations. In various embodiments, a sputtered layer (e.g., Ti or Ni) or an interlayer of glass mixed with a metal (e.g., Ni or Ag) is deposited on the cell prior to brazing. In various embodiments, the glass of seal 320 may include, consist essentially of, or consist of Al₂O₃, SiO₂, B₂O₃, BaO, MgO, La₂O₃, CaO, SrO, ZnO, and/or Li₂O. In various embodiments, the glass systems may include, consist essentially of, or consist of Al₂O₃—BaO—B₂O₃—SiO₂—CaO, SiO₂—Al₂O₃—SrO—ZnO—B₂O₃—Li₂O, SiO₂—BaO—MgO—La₂O₃—Al₂O₃—B₂O₃, or BaO—B₂O₃—SiO₂—Al₂O₃—ZnO. In various embodiments, the glass composition may include, consist essentially of, or consist of 1-55 wt % SiO₂, 0-50 wt % B₂O₃, 0-70 wt % BaO, 0-10 wt % CaO, 0-50 wt % Al₂O₃, 0-15 wt % La₂O₃, 0-30 wt % MgO, 0-35 wt % SrO, 0-35 wt % ZnO, and 0-5 wt % Li₂O. In various embodiments, all of the seals 320 in the SOFC may include, consist essentially of, or consist of the same material, while in other embodiments, at least two of the seals 320 include, consist essentially of, or consist of different materials. In various embodiments, the thickness of seal 320 may range from, for example, approximately 0.005 mm to approximately 15 mm. In various embodiments, the thickness of seal 320 may range from approximately 0.01 mm to approximately 10 mm, or approximately 0.05 mm to approximately 5 mm, or even approximately 0.05 mm to approximately 2 mm. In various embodiments, the individual gasket layers making up the seals 320 in a repeat unit (e.g., FIG. 3B) have the same thickness. In various embodiments, at least two of the individual gasket layers making up the seals 320 in a repeat unit have different thicknesses.

FIG. 3B also depicts the repeat unit 310 as including one or more current collectors 330 disposed between the cell 100 and the interconnect 200. In various embodiments of the invention, the current collector 330 may facilitate or improve electrical contact between the cell 100 and the interconnect 200, for example, when surface non-planarity of the cell 100 and/or the interconnect 200 might otherwise compromise or reduce electrical contact therebetween. The current collector 330 may also provide mechanical cushioning for the cell 100, for example, when temperature cycling of the SOFC 300 (and/or localized heating within one or more portions of the SOFC 300 during operation) results in differential thermal expansion within the SOFC. In various embodiments, current collectors 330 may be present at only one side of each cell 100 (e.g., the anode side), i.e., each repeat unit 310 may include only a single current collector 330 so that only one surface of the cell 100 is separated from a neighboring interconnect thereby. In other embodiments, SOFC 300 does not include current collectors 330. As shown in FIG. 3B, current collectors 330 may have the form of, or be at least partially composed of, a mesh, a perforated sheet, and expanded sheet, a fiber mat, a felt, a cloth, a foam (e.g., an expanded foam), or similar structure, and thus may feature porosity, holes, or other openings. The current collector 330 may be at least partially flexible, elastic, and/or springy to accommodate mechanical stresses and/or non-planarity within the SOFC 300. In various embodiments of the invention, one or more, or even all, of the current collectors 330 may include, consist essentially of, or consist of graphite. In various embodiments, the current collectors 330 may include, consist essentially of, or consist of a metal such as aluminum, stainless steel, copper, gold, platinum, etc. In various embodiments, the current collectors 330 may include, consist essentially of, or consist a metallic or ceramic coating on part or on all of the bulk current collector 330. For example, a current collector 330 may include a 430 stainless steel mesh coated by manganese-cobalt oxide (MCO), which is conductive at elevated temperatures and prevents undesirable oxidation of the stainless steel and reduces Cr volatility. In various embodiments, the current collectors 330 may include, consist essentially of, or consist of a ceramic material, such as Ca— and transition-metal doped yttrium chromite or lanthanum chromite doped with alkaline earth metals.

In various embodiments, one or more current collectors 330 may be applied as a film or layer on a different component of SOFC 300, e.g., the cell 100 and/or the interconnect 200. In various embodiments, the thickness of current collector 330 may range from approximately 0.0005 mm to approximately 15 mm, or approximately 0.0005 mm to approximately 5 mm, or approximately 0.001 mm to approximately 2.5 mm, or approximately 0.005 mm to approximately 1 mm, or even approximately 0.02 mm to approximately 0.75 mm. In various embodiments, a current collector 330 on either side of the cell 100 or on both sides cell 100 is composed of more than one layer. In various embodiments, the individual current collectors 330 on either side of the cell 100 have the same thickness. In various embodiments, at least two of the individual current collector layers making up the current collectors 330 have different thicknesses.

In various embodiments, the anode 130 and/or cathode 110 of cell 100 may additionally have electrical contact layers disposed on the surface of the anode or cathode. In various embodiments, for example, the anode 130 may have a thin layer of a metal such as nickel or silver deposited on the outer layer of the anode. In various embodiments, cathode 110 may have a thin layer of a metal such as silver or a ceramic such as LSC on the outer layer of the cathode. The electrical contact layer conducts entirely or primarily electrons and is intended to reduce the sheet resistance at the outer surface of the anode or cathode as the electrons travel between the cell 100 and interconnect 200. In various embodiments, the thickness of electrical contact layer disposed on the surface of the anode 130 and/or cathode 110 may range from approximately 0.005 mm to approximately 5 mm, or approximately 0.01 mm to approximately 3 mm, or even approximately 0.05 mm to approximately 1 mm. The electrical contact may be the same areal size or smaller than the electrode (i.e., cathode or anode) with which it is in contact.

As shown in FIG. 3A, the SOFC 300 may also incorporate endplates 340 above and below the repeat units 310. The endplates 340 may provide mechanical rigidity to the SOFC 300, as, in various embodiments, the SOFC 300 is clamped or fastened together via, e.g., one or more tie-rods, clamps (e.g., screw, band/strap, or toggle type clamps), or other fasteners.

SOFC stack 300 has a means by which oxygen supply 150 or fuel 160 are brought to the SOFC stack 300 and a means by which exhaust streams are directed away from the SOFC stack 300. In accordance with various embodiments, the manner in which the inlet (feed) and outlet (exhaust) gas streams are directed within the SOFC stack 300 as well as to and from the SOFC stack 300 or multiple SOFC stacks 300 is with direct gas connections and/or the use of gas distribution manifolds. A manifold divides a larger gas flow conduit to smaller gas flow conduit branches, or it combines smaller gas flow conduit branches to a larger gas flow conduit. In various embodiments, the gas manifold may be internal to (or integral to) the SOFC stack 300 (i.e., part of the stack itself) and directs gas to and from each repeat unit 310. In various embodiments, the SOFC stack 300 has an external manifold, which requires fluid connections to be made to the SOFC stack 300. In various embodiments, SOFC stack 300 has both internal and external manifolds. In various embodiments, the internal manifold and/or external manifold may include, consist essentially of, or consist of aluminum, graphite, stainless steel, or copper.

In various embodiments, one or both endplates 340 may also function as a connection point for an external manifold and as part of an internal manifold of the SOFC stack 300. For instance, as shown in FIG. 3A, SOFC stack 300 has inlet and outlet fluid connections 350 that bring oxygen supply 150 or fuel 160 to the stack and allow the exhaust streams to be directed away from the stack. Inside the SOFC stack 300, the oxygen supply 150 or fuel 160 are distributed through an internal manifold that delivers the correct reactant gases to the cathode 110 or anode 130 of each repeat unit 310. These gases may be delivered using different internal manifold 360 configurations. In various embodiments, the SOFC stack 300 may have a U-shaped internal manifold 360, in which the gases all enter and exit from, or essentially from, one side of the stack as shown in FIG. 3C. In various embodiments, the SOFC stack 300 may have a Z-shaped internal manifold 360, in which a gas stream that enters on one side of the stack exits from, or essentially from, the other side of the stack as shown in FIG. 3D. While FIGS. 3C and 3D show the counter-flow configuration, the internal manifold may also use alternate flow path arrangements (e.g., co-flow and cross-flow). In various embodiments, the SOFC stack 300 may have additional internal manifold configurations, such as a serpentine-shaped internal manifold. The co-flow configuration offers the lowest thermal gradient across cells 100 in SOFC stack 300. Counter- and co-flow configurations both offer much lower thermal gradients across cells 100 in SOFC stack 300 than a cross-flow configuration. The cross-flow configuration offers a simpler sealing and manifolding arrangement due to the greater separation of the anode 130 and cathode 110 flow streams. The use of materials with higher thermal conductivities (e.g., aluminum, graphite, and copper) in the SOFC stack 300 may reduce the thermal gradients across cells 100 and enable the use of cross-flow configurations for the simpler sealing/manifolding arrangement without the typical downside of relatively large thermal gradients. FIG. 3E provides additional detail for the internal manifold 360 and the fluid connections 350 in an exploded view of exemplary SOFC stack 300 components (i.e., endplates 340 and interconnects 200). Additional internal manifold configurations are possible. In various embodiments, rather than the inlet internal manifold 360 existing at the edges of the SOFC stack 300, the inlet manifold may exist at the center of the stack and pass through the holes in the center of all the cells 100. The exhaust streams in such an arrangement, may simply leave at the edges of the stack rather than through an internal manifold.

Rather than an internal manifold 360, the SOFC stack 300 may use a different manifold approach. FIG. 3F shows an SOFC stack 300 with repeat units 310 and endplates 340, but unlike in FIGS. 3C-3E, there are no fluid connections made to the endplates. In various embodiments, the SOFC stack 300 uses an external manifold arrangement that utilizes side plates 370 to distribute inlet and outlet flows to the SOFC stack 300. Side plates 370 seal to a stack frame 380, which runs from the top endplate 340 to the bottom endplate 340 in each corner of the stack. In the external manifold arrangement with side plates 370, the cell and interconnect seals 100 do not seal around the entire perimeter of the cell and/or interconnect as the seals 100 are arranged to prevent cross-over leaks rather than cross-over and external leaks. FIG. 3F shows a serpentine flow distribution (with a cross-flow path configuration) in which the gas stream enters into one section repeat units 310 of SOFC stack 300 through an inlet fluid connection 350 port. The gas stream changes directions after reaching the opposite side plate 370 and returns in a different section of repeat units 310. The gas stream goes back and forth in the serpentine flow pattern until reaching an exhaust fluid connection 350 port. In various embodiments, the SOFC stack 300 uses an external manifold arrangement with side plates 370 in a parallel flow path configuration (e.g., co-flow or counter-flow). In various embodiments, the SOFC stack 300 uses an external manifold arrangement with side plates 370 in a Z-shaped or U-shaped manifold configuration. In various embodiments, stack frame 380 and/or stack side plates 370 may include, consist essentially of, or consist of aluminum, graphite, and/or copper. In various embodiments, stack side plate 370 and/or stack frame 380 may include, consist essentially of, or consist of one or more of the materials detailed herein for interconnects 200 (e.g., stainless steel or an aluminum alloy). In various embodiments, side plates 370 may be sealed to stack frame 370 and/or the sides of endplates 340 using graphite, vermiculite, mica, and/or other seal materials detailed herein.

Fluid connections 350 to inlets and outlets of SOFC stack 300 may take many forms and may be made using any of a variety of joining methods. In various embodiments, connections to the inlets and outlets of the SOFC stack 300 are made using clamped flanges (e.g., clamped with nuts and tie-rods) and a metal seal (e.g., copper) or other seal (e.g., graphite, vermiculite, mica, or other seal materials detailed herein). In various embodiments, connections to the inlet and outlet fluid connections 350 of the SOFC stack 300 are made using tubes/pipes and various tube/pipe fittings (e.g., compression fittings). In various embodiments, connections to the inlet and outlet fluid connections 350 are made by welding or brazing tubing or pipes directly to the SOFC stack 300. In various embodiments, fluid connections 350 to SOFC stack 300 and/or connections to said fluid connections 350 (i.e., tubes/pipes and tube/pipe fittings) may include, consist essentially of, or consist of aluminum, graphite, and/or copper. In various embodiments, fluid connections 350 may include, consist essentially of, or consist of one or more of the materials detailed herein for interconnects 200 (e.g., stainless steel or an aluminum alloy). In various embodiments fluid connections 350 have a coating or cladding (e.g., nickel cladding or nickel plating) on the inside and/or outside of the fluid connection.

In various embodiments, connections to all or some of the fluid connections 350 are made from a single body (i.e., one piece of material with multiple internal passages) or multiple single body header manifolds. For example, in an SOFC-based power system, multiple SOFC stacks 300 may be connected, to a single external fuel reformer (i.e., a device that produces a syngas from, e.g., natural gas fuel) and/or a heat exchanger, by an external header manifold. In various embodiments, a branch from the external header manifold of the fuel 160 stream joins with multiple SOFC stacks 300 at the inlet fluid connection 350 for each stack. In various embodiments, the single body header feeds the oxygen source 150 and the fuel 160. In various embodiments, the single body header provides the exhaust conduit for the cathode and anode streams of the SOFC stack 300. In various embodiments, the single body header divides the inlets and combines the outlet (exhaust) streams. In various embodiments the external header manifolds may include, consist essentially of, or consist of aluminum, graphite, and/or copper. In various embodiments, external header manifolds may include, consist essentially of, or consist of one or more of the materials detailed herein for interconnects 200 (e.g., stainless steel or an aluminum alloy). In various embodiments, the external header manifold may be sealed to the SOFC stack 300 endplates 340 with a seal that may include, consist essentially of, or consist of graphite, vermiculite, mica, or other seal materials detailed herein.

In various embodiments, one or both endplates 340 may include, consist essentially of, or consist of aluminum, graphite, and/or copper. In various embodiments, one or both endplates 340 may include, consist essentially of, or consist of one or more of the materials detailed herein for interconnects 200 (e.g., stainless steel or an aluminum alloy). In various embodiments, the overall thickness of endplate 340 may range from, e.g., approximately 0.2 mm to approximately 30 mm. In various embodiments, the overall thickness of endplate 340 may range from approximately 1 mm to approximately 25 mm, approximately 5 mm to approximately 20 mm, or even approximately 10 mm to approximately 15 mm. In various embodiments, the minimum web thickness of endplate 340 may be approximately 0.15 mm to approximately 0.5 mm, or approximately 0.2 mm to approximately 0.4 mm, or even approximately 0.2 mm to approximately 0.3 mm. Endplates 340 may be fabricated utilizing conventional processes such as machining (e.g., milling), stamping, laser cutting, chemical etching, hydroforming, waterjet cutting, casting, pressing, injection molding, etc. In various embodiments, one or more endplates 340 have the same thickness as one or more interconnects 200.

In various embodiments, fluid connections 350 may include, consist essentially of, or consist of aluminum, graphite, and/or copper. In various embodiments, one or both fluid connections 350 may include, consist essentially of, or consist of one or more of the materials detailed herein for interconnects 200 (e.g., stainless steel or an aluminum alloy). In various embodiments, side plates 370 may include, consist essentially of, or consist of aluminum, graphite, and/or copper. In various embodiments, one or both side plates 370 may include, consist essentially of, or consist of one or more of the materials detailed herein for interconnects 200 (e.g., stainless steel or an aluminum alloy). In various embodiments stack frame 380 may include, consist essentially of, or consist of aluminum, graphite, and/or copper. In various embodiments, one or both stack frames 380 may include, consist essentially of, or consist of one or more of the materials detailed herein for interconnects 200 (e.g., stainless steel or an aluminum alloy). In various embodiments, one or more the endplates 340, side plates 370, interconnect 200, and stack frame 380 may include, consist essentially of, or consist of the same material, or two or more of them may include, consist essentially of, or consist of different materials.

In various embodiments, the cell and the interconnect are same size or are approximately the same size. FIG. 4A is a schematic perspective view for a repeat unit 310 of SOFC stack 300 in which a cell 100 and interconnect 200 have approximately the same in-plane dimensions (e.g., approximately the same size in length and width), and in which interconnect 200 is shown with contact ribs 410. When cell 100 is approximately the same size as interconnect 200 (also shown in FIG. 3B), the cell may contain holes or other through features, similar to the internal manifold 360 of interconnect 200 seen in FIG. 3E. The flow field of interconnect 200 may cover most or all of the interconnect and cell. In various embodiments, the flow field of interconnect 200 covers all of the interconnect except for the region in which the seal 320 resides. In various embodiments, the size of the flow field is defined by another component in the SOFC 300 stack, such as a porous mesh, perforated sheet, and expanded sheet, a fiber mat, a felt, a cloth, a foam (e.g., an expanded foam), or similar structure, and thus may feature porosity, holes, or other openings. In various embodiments, the size of the flow field is defined by the current collector 330.

Herein, the flow field refers to the area where various features (e.g., vanes, ribs, channels, plenum) are used to direct and distribute flow from the inlet to the inlet-side of the cell; across the cell; and from the outlet-side of the cell to the outlet. The plenum (or region before the cell) is primarily present to obtain as uniform a flow as possible across all the channels (or similar features) under the cell before the gas enters the channels. Thus, the flow field is the area with these features where the gas flows. The non-flow field area includes the manifold of the stack (inlet and outlet of individual interconnects), the outer sealing surface (i.e., not the seal made between the seal 320 and the cell 100 or if the seal 320 happens to be over the plenum), and any other features not involving gas flow (e.g., the voltage and current tabs, if there are any).

FIG. 4B is a cross-section of FIG. 4A along the dashed line 4B-4B and represents a cross-sectional schematic of an embodiment of SOFC 300 in which the endplates 340 are each in electrical contact with cells 100 of the repeat units 310. In such embodiments the power generated by the SOFC 300 may be pulled from the endplate(s) 340 or from busbars, or even tubing or other conductors, which are in electrical contact with the endplate 340. FIG. 4B may be considered to be a cross-section through a near-edge portion of the SOFC 300 (or even a side view thereof); thus, while the endplates 340 appear to be separated from cells 100 by a seal 320 in FIG. 4B, the endplates 340 and the cells 100 nearest thereto are in electrical contact in one or more locations closer to the center of the stack. In various embodiments of the invention, only one of the endplates 340 is in electrical contact with the cells 100, rather than both endplates 340. In various embodiments, at least one cell 100 is in electrical contact with at least one endplate 340, wherein the at least one endplate 340 is patterned (e.g., ribs, channels, or other flow field features) on the side in electrical contact with the cell, and the opposite side of the endplate 340 may be substantially planar.

FIG. 4C is a cross-section of FIG. 4A along the dashed line 4C-4C and represents a cross-sectional schematic of an embodiment of SOFC 300 proximate the middle region of the SOFC stack 300 and in which the endplates 340 are each in electrical contact with a cell 100. FIG. 4A shows a flow-field feature (e.g., a rib) on the interconnect 200 in part to distinguish the interconnect from the cell 100 in the schematic perspective view. FIG. 4C does not show a rib feature on interconnect 200 (nor on either endplate 340) in order to highlight configurations including a porous current collector 330 (e.g., a mesh). However, FIG. 4C may also represent the cross-section of an embodiment in which the flow field, in at least the active area of the SOFC 300, is defined only by porous current collectors 330 (e.g., one or meshes) rather than a patterned feature in the interconnect 200 (e.g., a contact rib) or endplate 340. The current collector 330 is smaller than the cell to accommodate the presence of seal 320 along the edges of the cell 100. In various embodiments, the width of the seal 320 on any edge of the cell 100 may vary from approximately 0.5 mm to approximately 30 mm, or approximately 1 mm to approximately 20 mm, or even approximately 5 mm to approximately 15 mm. While FIG. 4C is shown with a lateral gap between the seal 320 and the current collector 330, in various embodiments the edges of seal 320 and current collector 330 may abut or be nearly adjacent to each other (i.e., there may be no gap between the seal and current collector).

In various embodiments, one or both endplates 340 are electrically isolated from the cells 100 of the repeat units 310. Electrical isolation may be accomplished in many different ways, such as the use of an insulating gasket, insulating coating, or other insulating material. Such features may also be utilized to ensure that tie-rod or clamp fasteners maintain electrical isolation of the endplates 340. FIG. 4D is a cross-section of FIG. 4A along the dashed line 4B-4B and represents a cross-sectional schematic of an embodiment of SOFC 300 in which the endplates 340 are not in electrical contact with the cells 100. FIG. 4D may be considered to be a cross-section through a near-edge portion of the SOFC 300 (or even a side view thereof), in the manner of FIG. 4B; thus, the configuration of the layers in the SOFC stack may vary in one or more locations closer to the center of the stack. As shown, the cells 100 at the top and the bottom of the SOFC stack are not in electrical contact with the endplates 340. Rather, these cells 100 are electrically connected to terminal interconnects 400, which may be utilized to pull power from the entire SOFC stack. In various embodiments, the terminal interconnects 400 may include, consist essentially of, or consist of aluminum, copper, and/or graphite, or one or more of the materials set forth herein for interconnects 200. In various embodiments, terminal interconnects 400 may resemble interconnects 200 but may be patterned (e.g., with ribs and channels for gas flow; see FIG. 2) only on the side in electrical contact with a cell 100, and the opposite side of the terminal interconnect 400 may be substantially planar. FIG. 4E is a cross-section of FIG. 4A along the dashed line 4C-4C and represents a cross-sectional schematic of an embodiment of SOFC 300 proximate the middle region of the SOFC stack 300 and in which the endplates 340 are each electrically isolated from cells 100. FIG. 4E does not show a rib feature on interconnect 200 in order to highlight configurations including a porous current collector 330 (e.g., a mesh). However, FIG. 4E may also represent the cross-section of an embodiment in which the flow field, in at least the active area of the SOFC 300, is defined only by porous current collectors 330 (e.g., one or meshes) rather than a patterned feature in the interconnect 200 or terminal interconnect 400 (e.g., a contact rib).

In various embodiments, the cell and the interconnect are not the same size. FIG. 4F is a schematic perspective view for a repeat unit 310 of SOFC stack 300 where at least one of the in-plane dimensions (e.g., the length and/or width) of cell 100 are smaller than the in-plane dimensions (e.g., length and/or width) of interconnect 200. FIG. 4F shows a flow field feature (e.g., a rib) on the interconnect 200 in part to distinguish the interconnect from the cell 100 in the schematic perspective view. When the cell 100 is smaller than the interconnect, the cell need not, but may, contain holes or other through features. Moreover, when the cell is smaller than interconnect 200, SOFC stack 300 may utilize a spacer to support seals 320 in certain regions of the interconnect that are not overlapped with cell 100. In various embodiments, an SOFC stack 300 has in-plane dimensions (e.g., length and/or width) of cells 100 that are smaller than the in-plane dimensions (e.g., length and/or width) of the interconnect 200, and terminal interconnect 400 (if present), and/or one or both endplates 340. This is illustrated in, for example, FIG. 4G, which is a cross-section of FIG. 4F along the dashed line 4G-4G and represents a cross-sectional schematic of an embodiment of SOFC 300 in which the endplates 340 are each in electrical contact with cells 100 of the repeat units 310. In various embodiments, SOFC stack 300 includes a spacer 420 in the region of the interconnect 200 not overlapped with the cell 100. In various embodiments, spacer 420 may include, consist essentially of, or consist of the same material as the interconnect 200 (e.g., stainless steel, aluminum, copper, graphite, etc.) or any one or more materials described herein for interconnects. In various embodiments, spacer 420 may include, consist essentially of, or consist of the same material as the seal 320 or any one or more materials described herein for seals. In various embodiments, spacer 420 and seal 320 are a single piece of material or a single body (i.e., integrated into a single component).

FIG. 4H is a cross-section of FIG. 4F along the dashed line 4H-4H and represents a cross-sectional schematic of an embodiment of SOFC 300 proximate the middle region of the SOFC stack 300 and in which the endplates 340 are each in electrical contact with a cell 100. FIG. 4F shows a flow-field feature (e.g., a rib) on the interconnect 200 in part to distinguish the interconnect from the cell 100 in the schematic perspective view. FIG. 4H does not show a rib feature on interconnect 200 in order to highlight configurations including a porous current collector 330 (e.g., a mesh). However, FIG. 4H may also represent the cross-section of an embodiment in which the flow field, in at least the active area of the SOFC 300, is defined only by porous current collectors 330 (e.g., one or meshes) rather than a patterned feature in the interconnect 200 (e.g., a contact rib). The current collector 330 is smaller than the cell to accommodate the presence of seal 320 along the edges of the cell 100. Seal 320 extends from the edge of the cell 100 to the spacer 420. FIG. 4H shows the outside edge of seal 320 extending all the way to the edge of spacer 420. In various embodiments, the outside edge of seal 320 extends all the way to the edge of spacer 420. In various embodiments, the outside edge of spacer 420 extends beyond one or both of seals 320 for any given repeat unit 310 of SOFC stack 300. In various embodiments, the outside edge of one or both seals 320 extend beyond spacer 420. While FIG. 4H is shown with a gap between the seal 320 and the current collector 330, in various embodiments the edges of seal 320 and current collector 330 may abut or be nearly adjacent to each other (i.e., there may be no gap between the seal and current collector). While FIG. 4H is shown with a lateral gap between the seal 320 and the current collector 330, in various embodiments the edges of seal 320 and current collector 330 may abut or be nearly adjacent to each other (i.e., there may be no gap between the seal and current collector). Similarly, while FIG. 4H is shown with a lateral gap between the spacer 420 and the cell 100, in various embodiments the edges of spacer 420 and cell 100 may abut or be nearly adjacent to each other (i.e., there may be no gap between the spacer and cell).

In various embodiments, an SOFC stack 300 has in-plane dimensions (e.g., length and/or width) of cells 100 that are smaller than the in-plane dimensions (e.g., length and/or width) of the interconnect 200, and terminal interconnect 400 (if present), and/or one or both endplates 340 are electrically isolated from the cells 100 of the repeat units 310. Electrical isolation may be accomplished in many different ways, such as the use of an insulating gasket, insulating coating, or other insulating material. Such features may also be utilized to ensure that tie-rod or clamp fasteners maintain electrical isolation of the endplates 340. FIG. 4I is a cross-section of FIG. 4F along the dashed line 4H-4H and represents a cross-sectional schematic of an embodiment of SOFC 300 proximate the middle region of the SOFC stack 300 and in which the endplates 340 are each electrically isolated from cells 100. Unlike FIG. 4H, the interconnects 200 and terminal interconnects 400 in FIG. 4I include a rib flow feature but do not include current collectors 330. While FIG. 4I is shown with a lateral gap between the seal 320 and the current collector 330, in various embodiments the edges of seal 320 and the rib feature of interconnect 200 or terminal interconnect 400 may abut or be nearly adjacent to each other (i.e., there may be no gap between the seal and interconnect). Similarly, while FIG. 4I is shown with a lateral gap between the spacer 420 and the cell 100, in various embodiments the edges of spacer 420 and cell 100 may abut or be nearly adjacent to each other (i.e., there may be no gap between the spacer and cell).

Various embodiments of the present invention may utilize hybrid, or multilayer, seals 320 that each include, consist essentially of, or consist of two or more different materials. Such seals 320 may be advantageous for the sealing of metallic materials to ceramic materials and/or for the sealing together of two different metallic or ceramic materials. Such hybrid, or multilayer, seals 320 may also be advantageous when a seal material is electrically conductive (e.g., graphite), such that the use of a second seal material in a hybrid, or multilayer structure, may prevent electrical shorting in some stack designs. Hybrid, or multilayer, seal 320 may also be advantageous when a seal material is, for example more stable in a reducing environment than an oxidizing environment (or vice versa), such that the hybrid seal enables the use of the first material by combination with another material that is stable in at least an oxidizing environment (or at least in a reducing environment). (In accordance with various embodiments of the invention, a gas environment is “reducing” if the partial pressure of oxygen is less than or equal to 10⁻¹⁸ atm, and a gas environment is “oxidizing” if the partial pressure of oxygen is greater than 10⁻¹⁸ atm.) FIG. 5A is a side view of a hybrid seal 320 composed of layers 500, 510. In various embodiments, at least one of the layers 500, 510 includes, consists essentially of, or consists of graphite. In various embodiments, one of the layers 500, 510 is electrically conductive while the other layer is electrically insulating. (As utilized herein, a component or layer that is “electrically conductive” has a minimum electrical conductivity of at least 10 S/m, or ranging from approximately 10 S/m to approximately 10⁶ S/m, or ranging from approximately 10³ to 10⁶ S/m, or even higher, at least at the operating temperature (e.g., from approximately 400° C. to approximately 800° C., or even higher); a component or layer that is “electrically insulating” has a minimum resistivity of at least 10³ ohm-m, or ranging from approximately 10³ ohm-m to approximately 10⁶ ohm-m, or even higher, at least at the operating temperature.)

In various embodiments in which a seal 320 (and/or layers 500, 510) includes, consists essentially of, or consists of graphite, the graphite material used in seal 320 and/or in one or both of layers 500, 510 may each include, consist essentially of, or consist of a flake graphite, amorphous graphite, crystalline graphite, pyrolytic graphite, highly ordered pyrolytic graphite (HPOG), pyrolytic carbon, carbon black, activated carbon, carbon fiber, graphene, polycrystalline graphite, synthetic graphite, and/or glass-like carbon (e.g., glassy or vitreous carbon). In various embodiments, layers 500, 510 may each include, consist essentially of, or consist of a different type of graphite. For example, one layer may include, consist essentially of, or consist of oxidized graphite (e.g., graphite exposed to an oxidizing ambient), while the other layer may include, consist essentially of, or consist of reduced graphite (e.g., graphite exposed to a reducing ambient). In another example, one layer may include, consist essentially of, or consist of glassy carbon (i.e., a vitreous graphite), while the other layer may include, consist essentially of, or consist of flake graphite. In various embodiments, one of the layers 500, 510 may include, consist essentially of, or consist of graphite, while the other layer may include, consist essentially of, or consist of one or more other materials such as mica, vermiculite, glass, brazing alloys, asbestos, polyamides (e.g., aramid), talc, polyimides (e.g., Kapton), polyamide-imides (e.g., Torlon), polysiloxane (e.g., a silicone or an RTV silicone), and/or silsesquioxanes (e.g., phenyl silsesquioxanes). In various embodiments layers 500, 510 may be coated with a different type of carbon/graphite than the carbon/graphite making up either layer 500, 510. In various embodiments, the band of appropriate operating temperatures for polyimide-, polyamide-, polyamide-imide-, polysiloxane-, or silsesquioxane-based materials in seal 320 ranges from approximately 300° C. to approximately 750° C. In various embodiments, the band of appropriate operating temperatures for polyimide-, polyamide-, polysiloxane-, or silsesquioxane-based materials in seal 320 ranges from approximately 350° C. to approximately 650° C. In various embodiments, the band of appropriate operating temperatures for polyimide-, polyamide-, polyamide-imide-, polysiloxane-, or silsesquioxane-based materials in seal 320 ranges from approximately 400° C. to approximately 500° C. In various embodiments, the band of appropriate operating temperatures for graphite-based materials in seal 320 ranges from approximately 300° C. to approximately 1000° C. in a reducing environment. In various embodiments, the band of appropriate operating temperatures for graphite-based materials in seal 320 ranges from approximately 350° C. to approximately 850° C. in a reducing environment. In various embodiments, the band of appropriate operating temperatures for graphite-based materials in seal 320 ranges from approximately 300° C. to approximately 750° C. in an oxidizing environment. In various embodiments, the band of appropriate operating temperatures for graphite-based materials in seal 320 ranges from approximately 300° C. to approximately 650° C. in an oxidizing environment. In various embodiments, the band of appropriate operating temperatures for graphite-based materials in seal 320 ranges from approximately 300° C. to approximately 550° C. in an oxidizing environment. In various embodiments, the band of appropriate operating temperatures for mica, vermiculite, glass, brazing alloys, asbestos, or talc materials in seal 320 ranges from approximately 300° C. to approximately 1000° C. in an oxidizing or reducing environment.

An adhesive may be utilized to bond the layers 500, 510 together or to seal 320. The use of such an adhesive may be advantageous to help form a superior interfacial seal between the layers 500 and 510 and/or to simply the stack 300 assembly process. In various embodiments, the adhesive is applied to one or both layers. In various embodiments, layers 500, 510 are laminated (e.g., using calendaring lamination) after the adhesive is applied. In various embodiments, adhesives may include, consist essentially of, or consist of a single component or multiple components. In various embodiments, adhesives may be electrically resistive with low or high thermal conductivity, or they may be electrically conductive with high thermal conductivity. In various embodiments, adhesives may include, consist essentially of, or consist of organic and/or inorganic compounds. In various embodiments, adhesives may include, consist essentially of, or consist of a binder and/or a reactive compound. In various embodiments, adhesives may include, consist essentially of, or consist of inorganic materials (e.g., lime, MgO, Al₂O₃, Zr, YSZ, and/or various types of ceramic cements). In various embodiments, ceramic cements used adhesives may include, consist essentially of, or consist of aluminum phosphate, sodium silicate, and/or calcium silicate. In various embodiments, adhesives may include, consist essentially of, or consist of organic materials (e.g., styrene butadiene rubber (SBR), polyvinyl butyral, polyurethane, polyacrylonitrile (PAN), ethylene propylene diene monomer (EPDM) rubber, and/or nitrile butadiene rubber (NBR)). In various embodiments, adhesives may include, consist essentially of, or consist of graphite-based adhesives (e.g., Ceramabond 551-RN and Ceramabond 669 from Aremco). In various embodiments, adhesives may include, consist essentially of, or consist of electrically resistive adhesives, which may also be either thermally resistive (e.g., Resbond 919 from Cotronics) or thermally conductive (e.g., Resbond 920 from Cotronics). In various embodiments, adhesives may include, consist essentially of, or consist of electrically conductive adhesives (e.g., Durabond 950, 952, or 954 from Cotronics; or Corr-Paint, e.g., the CP30xx series, from Aremco).

As shown in FIGS. 5B and 5C, a seal 320 (either a uniform seal or a hybrid/multilayer seal as shown in FIG. 5A) may be coated on one or both of its sealing surfaces in order to, e.g., enhance interfacial sealing between different components in an SOFC stack. Such coatings may be advantageously utilized, e.g., in embodiments in which the seal includes, consists essentially of, or consists of graphite or is composed of one or more layers including, consisting essentially of, or consisting of graphite. For example, one or both sealing surfaces (e.g., the top surface and/or the bottom surface) of a seal 320 may be coated with a coating 520 that may include, consist essentially of, or consist of, for example, glass or a non-glass sealant such as a vermiculite, mica, asbestos, polysiloxane (e.g., an RTV silicone), a brazing material, a polyamide (e.g., aramid), talc, a polyimide (e.g., Kapton), a polyamide-imide (e.g., Torlon), or a silsesquioxane (e.g., phenyl silsesquioxane). In various embodiments, the coating 520 is electrically insulating to, e.g., help avoid electrical shorts within the SOFC stack. As shown in FIGS. 5D and 5E, it may be advantageous to coat only a portion of one or the other of the sealing surfaces of a seal 320 with coating 520. For example, partial coatings 520 may be utilized when sealing various parts of the SOFC stack that are otherwise not compatible or easily sealed together (e.g., composed of different materials).

SOFCs in accordance with various embodiments of the present invention may feature one or more external seals, or “encapsulants,” on one or more outer surfaces of the SOFC stacks (e.g., disposed on or around the SOFC stack, rather than between layers thereof), in addition to one or more seals 320. Such external seals may be advantageous to encapsulate one or more components of the SOFC stack that include, consist essentially of, or consist of readily oxidizable materials (e.g., graphite) in order to prevent exposure of such components to ambient air (to, e.g., prevent oxidation). FIGS. 6A and 6B are schematic cross-sections through edge portions of an SOFC stack (i.e., in the manner of FIG. 4A) illustrating the placement of external seals 600. Although the cross-sectional views of FIGS. 6A and 6B necessarily depict the external seals 600 on either side of the SOFC stack, in various embodiments of the invention the external seals 600 wrap around the entirety of the perimeter of the SOFC stack. In various embodiments, the external seal 600 may include, consist essentially of, or consist of glass, a non-glass sealant such as a polysiloxane (e.g., an RTV silicone), or a ceramic cement. Ceramic cements may include, consist essentially of, or consist of aluminum phosphate, sodium silicate, calcium silicate, Al₂O₃, MgO, Zr, or YSZ (e.g., various product offerings under the tradename Ceramabond from Aremco and the tradename Durapot from Cotronics). In various embodiments, the external seal 600 is electrically insulating. In various embodiments, the external seal 600 is semiconducting with a resistivity between that of a conductor and insulator. FIG. 6A depicts the external seal 600 as extending across the cell 100, seals 320, and at least portions of interconnects 200 (although FIG. 6A depicts the external seal 600 as covering only a portion of the interconnects 200, embodiments of the invention include embodiments in which the entirety of the side surface of one or more interconnects 200 is covered by the external seal 600). FIG. 6B depicts an external seal 600 as extending across a seal 320 and portions of a cell 100 and an interconnect 200, i.e., essentially only the seal 320 is completely encapsulated by the external seal 600. In various embodiments of the invention, one or both interconnects 200 may be replaced by an endplate 340 and/or a terminal interconnect 400. Thus, in various embodiments of the invention, one or more external seals 600 may be utilized to encapsulate side surfaces of one or more components of the SOFC stack that include, consist essentially of, or consist of, at least in part, graphite. In various embodiments, an external seal 600 may cover all or substantially all of the outer surfaces of the entire SOFC stack (e.g., SOFC 300 depicted in FIG. 3A). In various embodiments, external seal 600 covers approximately 0.01% to approximately 100% of the outer surface of the entire SOFC stack. In various embodiments, external seal 600 covers approximately 15% to approximately 75%, or even approximately 25% to approximately 50%, of the outer surface of the entire SOFC stack. In various embodiments, the external seals 600 are between the layers of the SOFC stack 300, but arranged further away from the center of the stack than seals 320 (e.g., FIG. 6C in the manner of FIG. 4I) and “encapsulate”, for example, seals 320. In various embodiments, external seals 600 are the same thickness as seals 320. In various embodiments, the thickness of external seals 600 ranges from approximately 0.001 mm to approximately 20 mm, approximately 0.1 mm to approximately 10 mm, and even approximately 1 mm to approximately 5 mm.

In various embodiments of the invention, one or more portions of an interconnect 200 are coated in order to maintain high electrical conductivity, particularly during operation of the SOFC. FIG. 7A is a schematic perspective view of the flow field region of an interconnect 200 showing a plurality of contact ribs 700 separated by flow channels 710. In various embodiments, as also indicated on FIG. 2, the contact ribs 700 maintain electrical contact with adjoining cells 100 while the flow channels 710 conduct oxygen source 150 and/or fuel 160 therethrough. As shown, the contact ribs 700 and flow channels 710 may be coated by a coating 720 that is electrically conductive. (As utilized herein, a “coating” is understood to refer to not only deposited coatings but also laminated claddings, while “cladding” includes only claddings and not other types of coatings.) In various embodiments, the coating 720 retards or prevents oxidation of the contact ribs 700, thereby maintaining high electrical conductivity thereof. In various embodiments, other portions of the flow field (e.g., the inlet or outlet plenum) may be coated by a coating 720. Coating 720 may be particularly advantageous when interconnect 200 includes, consists essentially of, or consists of aluminum, but coating 720 may also be utilized with other interconnect materials detailed herein for interconnects 200 (e.g., stainless steel or copper). In various embodiments, the coating 720 may include, consist essentially of, or consist of, for example, a nitride layer (e.g., TiN, ZrN, nickel nitride, tantalum nitride, tungsten nitride, vanadium nitride, niobium nitride, Indium nitride, gallium nitride, Zn₃N₂, Cu₃N, boron nitride, Si₃N₄, C₃N₄, etc.), a carbide layer (e.g., TiC, SiC, TaC, NbC, ZrC, WC, etc.), one or more metals (e.g., Ag and/or Ni), one or more aluminum intermetallics (e.g. TiAl, MgAl, FeAl, or NiAl), graphite, and/or an electrically conductive ceramic oxide such as manganese-cobalt oxide (MCO). In various embodiments, nitrides are ternary or higher compounds, including nitrogen with one of Li, Ba, Sr, or Ca; and one of V, Nb, Ta, Hf, Zr, Ti, Si, Ge, C, B, W, Mo, Cr, Mn, Fe, Co, Ni, In, Ga, Al, Bi, Sb, Sn, or Y (e.g., CaNiN or SrNiN); or nitrogen; one of Mg or Zn; and one of V, Nb, a, Hf, Zr, Ti, Si, Ge, C, B, W, Mo, Cr, Mn, Sb, or Sn (e.g., Mg₂Ta₂N₃); or nitrogen; one of Na or K; and one of V, Nb, a, Hf, Zr, Ti, Si, Ge, C, B, W, Mo, Cr, Mn, or Sn; or nitrogen; one of Nb or Ta; and one of Fe, Co, Ni, Si, or Zr (e.g., Ta₄Ni₂N); or nitrogen; Al; and one of Nb, Hf, Zr, Ti, or C (e.g., TiAlN or Ti₂AlN); or nitrogen; Mo; and one of Mn, Fe, Co, Ni, or Si (e.g., Ni₂Mo₃N). In various embodiments, carbides are ternary or higher compounds, including carbon with one of Ti, V, Zr, Cr, Nb, Hf, or Ta; and one of Al, Ga, In, Ge, Sn, Pb, S, P, Si, or Zn (e.g., Ti₃SiC₂). In various embodiments, the coating 720 may include, consist essentially of, or consist of a conversion coating incorporating, and partially formed of, the material of the interconnect 200 (e.g., in a chemical or electrochemical process). In various embodiments, coatings may be treated with ion implantation (e.g., Al ion implantation into TiN) to increase their oxidation resistance or otherwise increase the onset temperature of oxidation.

In various embodiments, the coating 720 includes, consists essentially of, or consists of nickel. For example, a graphite interconnect 200 may include a nickel coating 720 to improve interfacial conductivity. While such a Ni coating may be used on either side of the interconnect in certain cases, it is more appropriate for use on the anode to avoid oxidation of the nickel to resistive nickel oxide at SOFC operating temperatures. In various embodiments, an interconnect 200 may have a nickel coating 720 to protect the copper from oxidation, which may still be used for bulk conduction of electricity even if the nickel oxide coating becomes resistive. Such a coating may be used on either the anode or cathode side of the interconnect. In various embodiments, an interconnect 200 may have a coating of aluminum, copper, or stainless steel. In various embodiments, an aluminum interconnect 200 has a coating of copper, nickel, or stainless steel. In various embodiments, a copper interconnect 200 has a coating of aluminum, nickel, or stainless steel. In various embodiments, a stainless steel interconnect 200 has a coating of copper, nickel, or aluminum. In various embodiments, the coating is a cladding.

FIG. 7B is a cross-section of FIG. 7A along the dashed line 7B-7B. As shown, in various embodiments of the invention the coating 720 may coat (e.g., conformally coat) not only the top surfaces of the contact ribs 700, but also the side surfaces of the contact ribs 700 and the bottom surfaces of the flow channels 710. However, in other embodiments, only the top surfaces of the contact ribs 700 that contact adjoining components are coated with the coating 720, while the side surfaces of contact ribs 700 and/or the bottom surfaces of the flow channels 710 are uncoated. In various embodiments, the thickness of the coating 720 may range from, e.g., approximately 0.0001 mm to approximately 10 mm. In various embodiments, the thickness of coating 720 may range from approximately 0.0005 mm to approximately 1 mm, approximately 0.001 mm to approximately 0.75 mm, or even from approximately 0.005 to approximately 0.5 mm. In various embodiments, the coating 720 may be formed via conventional processes such as, e.g., physical vapor deposition, chemical vapor deposition, spray coating, dip coating, plating, pack cementation, diffusion coating, conversion coating, screen printing, gravure printing, or pad printing. In various embodiments the coating 720 is formed via a cladding process, which may utilize, for example, different lamination, extrusion, brazing, laser sintering (i.e., laser cladding), or even diffusion bonding steps. In various embodiments of the invention, an interconnect may have coatings 720 on two different surfaces (e.g., top and bottom surfaces), and the two coatings 720 may have different compositions. In addition, the coating 720 on one surface may coat only the tops of the contact ribs 700 while the coating 720 on the other surface may coat not only the tops of the contact ribs 700 but other portions of the surface such as the side surfaces of the contact ribs 700 and/or the bottom surfaces of the flow channels 710.

In various embodiments of the invention, it may be advantageous to electrically isolate various components, or portions thereof, from other components within the SOFC stack. FIGS. 8A and 8B depict cross-sections of configurations in which a component 800 incorporates one or more insulating layers 810 on one or more surfaces. The component 800 may be, e.g., an interconnect 200, a terminal interconnect 400, an endplate 340, or a seal 320. The insulating layer 810 may be present on the component 800 in one or more locations at interfaces with other components in the SOFC stack where electrical insulation between component 800 and the other component(s) is desired (e.g., at the outer edges of the SOFC stack). In various embodiments, the insulating layer 810 may include, consist essentially of, or consist of, for example, glass and/or a ceramic layer (e.g., a nitride such as silicon nitride and/or an oxide such as aluminum oxide or magnesium oxide, or even an oxynitride or oxycarbide such as any of the nitrides or carbides listed herein with the addition of oxygen to the compounds). In embodiments in which the component 800 includes, consists essentially of, or consists of aluminum, all or a portion of the insulating layer 810 may include, consist essentially of, or consist of aluminum oxide (e.g., a native aluminum oxide). For example, an interconnect 200 may have a coating 720 disposed over the flow field region of the interconnect, while the remaining (e.g., edge) portions of the interconnect 200 may be heat treated in an oxygen-containing ambient to form an aluminum oxide insulating layer 810 over the remaining portions. In various embodiments, the thickness of the insulating layer 810 may range from, e.g., approximately 10 nm to approximately 5 mm. In various embodiments, the insulating layer 810 may be formed via conventional processes such as, e.g., physical vapor deposition, chemical vapor deposition, spray coating, dip coating, plating, conversion coating, screen printing, gravure printing, or pad printing.

In various embodiments in which a seal 320 includes, consists essentially of, or consists of graphite, all or part of at least one sealing surface (e.g., top and/or bottom surface) of the seal 320 may incorporate an insulating layer 810 thereon to prevent electrical conduction through the seal 320. In this manner, both seals 320 and interconnects 200 within SOFCs in accordance with embodiments of the invention may include, consist essentially of, or consist of graphite. In various embodiments in which a seal 320 includes, consists essentially of, or consists of a metal (e.g., aluminum or copper) or electrically conductive ceramic, all or part of at least one sealing surface (e.g., top and/or bottom surface) of the seal 320 may incorporate an insulating layer 810 thereon to prevent electrical conduction through the seal 320.

Embodiments of the present invention feature various different configurations of interconnects 200 and/or seals 320 within the SOFC stack. FIG. 9 is a cross-sectional schematic of a repeat unit 310 and an adjoining interconnect 200 depicting the configuration thereof. As opposed to the cross-sectional diagrams of FIGS. 4A-4H, FIG. 9 is a cross-section of an SOFC 300 taken proximate the center of the SOFC stack, perpendicular to the flow channel and interconnect ribs (in the manner of dashed line 7B-7B in FIG. 7A), revealing various details of the SOFC layer configuration. As shown, the cell 100 is disposed between and in electrical contact with the two interconnects 200, and a current collector 330 and a coating 720 facilitate the electrical connection on either side of the cell 100. In various embodiments, the current collectors 330 on either side of the cell 100 may have the same composition, or they may have different compositions. Likewise, the coatings 720 making contact to the current collectors 330 on either side of the cell (i.e., the coatings 720 on either side of each interconnect 200) may have the same composition, or they may have different compositions.

Closer to the periphery of the SOFC stack, a hybrid seal 320 having layers 500, 510 is also disposed between each side of the cell 100 and the adjoining interconnect 200. As shown, both sides of each hybrid seal 320 may have an insulating layer 810 disposed thereon. In various embodiments, only one surface of the hybrid seal 320 (i.e., only one of layers 500, 510) may have an insulating layer 810 disposed thereon, or all of the insulating layers 810 may be omitted, particularly in embodiments in which hybrid seal 320 (or a portion thereof, e.g., layer 500 and/or layer 510) is electrically insulating. An external seal 600 may be disposed around the assembly shown in FIG. 9 for encapsulation and prevention of oxidation (or other deleterious exposure to the surrounding ambient). The external seal 600 may be particularly advantageous in embodiments of the invention in which all or a portion of the interconnects 200 or the hybrid seals 320 includes, consists essentially of, or consists of graphite. FIG. 9 also depicts a spacer 900 disposed between the two hybrid seals 320 on either side of the cell 100. In various embodiments, the spacer 900 has approximately the same thickness of the cell 100 and occupies the gap between the hybrid spacers 320 in embodiments in which the cell 100 does not extend out by the same lateral distance as the interconnects 200 and/or seals 320, thereby contributing mechanical strength and stability to the SOFC stack. The spacer 900 may have any of the properties and/or structures, and/or be composed of any of the materials, detailed herein for spacer 420. In various embodiments, the spacer 900 may be an extension of one or both seals 320 rather than a discrete component. In various embodiments, the spacer 900 has a composition selected from any of the materials detailed herein for the interconnect 200 or the seal 320. In various embodiments, the spacer 900 is electrically insulating, while in other embodiments (particularly those in which insulating layers 810 are present as shown in FIG. 9), the spacer 900 may be electrically conductive.

FIG. 10 depicts another cross-sectional schematic of a portion of an SOFC stack, proximate the center of the stack, in accordance with embodiments of the invention. In the embodiment depicted in FIG. 10, the interconnect 200 is shaped at its outer periphery to provide sealing (i.e., to function as a seal 320 would) at least on one surface of the interconnect 200. As shown, one surface of the interconnect 200 itself makes direct mechanical contact with the cell 100 (and, if present, the optional spacer 900), while a seal 320 (which may be, in various embodiments, a hybrid seal 320) is disposed between the cell 100 and the opposite surface of the other interconnect 200. As shown, an insulating layer 810 may be present on one or more (e.g., top and/or bottom) surfaces of the seal 320. As also shown, an external seal 600 may be disposed around the SOFC stack to encapsulate at least each interconnect 200, and this arrangement may be particularly advantageous in embodiments in which the interconnects 200 include, consist essentially of, or consist of graphite. In various embodiments, the interconnect 200 may be shaped to function as a seal on both the top and bottom surfaces of the interconnect 200, i.e., the outer periphery of the top surface of interconnect 200 may be shaped to make direct contact with the cell 100, such that cell 100 is directly contacted at its outer periphery by interconnects 200 on opposing sides of cell 100. However, in various embodiments, the use of a separate seal 320 may facilitate sealing of the SOFC stack under a wide variety of conditions, e.g., different temperature regimes, during startup, etc., as the seal 320 may be more mechanically pliable or flexible and maintain sealing of the stack even as various components of the stack expand or contract during temperature changes.

As shown in FIG. 10, the external seal 600 may not cover or encapsulate all or portions of one or more layers of the SOFC stack, e.g., seal 320 and/or spacer 900. However, if any such layers include, consist essentially of, or consist of graphite, in various embodiments the external seal 600 may cover and encapsulate such layers to reduce or prevent oxidation thereof.

FIG. 11 is a cross-sectional schematic similar to that of FIG. 10 but depicting an embodiment of the present invention without the optional current collectors 330. Rather, as shown, the cell 100 itself is disposed in direct mechanical (as well as electrical) contact with the interconnects 200, e.g., via optional coatings 720 (that is, in various embodiments, the coatings 720 may not be present on the interconnects 200, which may still make direct mechanical contact with cell 100).

In various embodiments, an interconnected-supported cell is disposed on top of an interconnect that includes, consists essentially of, or consists of aluminum, graphite, or copper. In various embodiments, the interconnect of an interconnect-supported cell is fully dense (i.e., lacking significant (e.g., >1%) open porosity). In various embodiments, a portion of the interconnect of an interconnect-supported cell is porous (i.e., has open porosity). In various embodiments, one side (i.e., anode side or cathode side) of the interconnect of an interconnect-supported cell is porous. In various embodiments, both sides of the interconnect of an interconnect-supported cell are porous. In various embodiments, the extent of the porous portion of the interconnect is approximately 10% to approximately 80% of the total thickness of the interconnect. In various embodiments, the extent of the porous portion of the interconnect is approximately 15% to approximately 60% of the total thickness of the interconnect. In various embodiments, the extent of the porous portion of the interconnect is approximately 20% to approximately 50% of the total thickness of the interconnect.

In various embodiments, SOFC stack 300 is designed for long-term use (e.g., multiple years, such as 10 or 20 years). In various embodiments, SOFC stack 300 is not designed for long-term use (e.g., multiple years), but rather for short-term use. In various embodiments, SOFC stack 300 is designed for a useful lifetime of less than or equal to five years. In various embodiments, SOFC stack 300 is designed for a useful lifetime of less than or equal to three years. In various embodiments, SOFC stack 300 is designed for a useful lifetime of less than or equal to twelve months. In various embodiments, SOFC stack 300 is designed for a useful lifetime of less than or equal to six months. In various embodiments, SOFC stack 300 is designed for a useful lifetime of less than or equal to one month. In various embodiments, SOFC stack 300 is designed for a useful lifetime of less than or equal to one week.

### EXAMPLES

Various different materials, coatings, and configurations were utilized to assess the performance of SOFC stack components (gaskets and interconnects) independently and with integrated SOFC stacks at elevated temperatures. In the first test involving gaskets, different gasket materials were screened in a stagnant flow (SF) type configuration to measure bulk and interfacial leak paths. The setup featured two stainless steel flanges with stainless steel tubing welded to each flange. In the SF configuration disks of gasket material were placed between the flanges and compressed using threaded tie-rods, nuts, and spring washers. The uncompressed centers of the gasket disks were essentially membranes that allowed for assessment of the bulk leak path through the middle of the various gasket materials. A porous support was used to keep the middle section of the gasket from rupturing under high gas backpressure.

The test fixture was heated to different temperatures between 350° C. and 650° C. in a clamshell furnace under varied gas environments (inert, reducing, and oxidizing) and at a back pressure of 0.5 psig, which was maintained with a back pressure regulator (BPR) on the upstream side of the setup. A single cycle consisted of a ramp from ˜100° C. to 350° C. and ultimately 650° C. with steps every 100° C. Each temperature setpoint was maintained for ˜4 hours. After the last step, the furnace was cooled back to ˜100° C. and the process was repeated. Leakage measurements were collected continuously at each step. The process was repeated for a total of three cycles over a 50-hour period. All flows into the test fixture were computer controlled via mass flow controller (MFC) and verified using high accuracy, digital, volumetric flow meters. Hydrogen was flowed on one side of the membrane, while a helium sweep gas was flowed on the other side. The sweep gas was monitored for hydrogen using gas chromatography to quantity bulk leakage through the gasket. A species balance was conducted to quantify interfacial and bulk leak rates.

Vermiculite and graphite gasket materials were investigated at different operating temperatures and gasket seating pressures (i.e., low, medium, and high). A talc-based gasket was also evaluated but not fully pursued because, despite the presence of the porous support, the relatively weaker talc gasket experienced mechanical strength issues in uncompressed regions of the SF configuration. Talc-based gaskets should be preferably reinforced to prevent blowout.

The fuel leak fractions were compared for each material and gasket seating stress combination for the different temperatures. In every case, the leak rates for the graphite gasket were less than 1% of the hydrogen that was injected into the setup. For the medium and high seating stress cases, the vermiculite gaskets had leak rates below 1%. For the low seating stress, however, the vermiculite gaskets displayed leak rates between 1.5% and 2% for 350° C. to 550° C. At 650° C., the leak rate was a high as ˜7%. There was a general trend of slightly decreasing leak rates with increasing temperatures in most of the cases for each material, which related to decreased interfacial leakage as the flanges expanded more against the gasket material at higher temperatures. For the graphite gasket, multiple thermal cycles at various temperatures between 100° C. and 650° C. had little impact on sealing performance. In one case, the graphite gasket was run for a total of 10 cycles over 160 hours and exhibited little to no change in leak rates. Performance of the vermiculite gaskets, on the other hand, displayed a greater degree of relaxation and appeared in some cases to change during thermal cycles. Table 1 provides a summary of the total leak rates (percentage of input stream that leaked), which were derived from the SF configuration measurements at ˜450° C. for the graphite and vermiculite gasket materials at low and high seating stress. As expected, the high seating stress samples had lower leak rates than the low seating stress samples. The graphite gaskets performed much better overall than the vermiculite gaskets. (Note that, for the low-stress vermiculite sample, smaller-diameter tie rods were tightened to the same torque value as the low-stress graphite sample, resulting in a slightly different seating stress.)

TABLE 1
Leak rates for different gaskets and
seating stress in SF configuration

| | Estimated | | Leak Rates (%) |
|---|---|---|---|
| | Gasket Seating | Temperature | for 0.5 psig |
| Material | Stress (MPa) | (° C.) | feed pressure |
| Graphite | 4.5 | 455.2 | 1.00% |
| | (low) | | |
| Graphite | 16.5 | 451.7 | 0.78% |
| | (high) | | |
| Vermiculite | 6.0 | 454.4 | 1.60% |
| | (low) | | |
| Vermiculite | 16.5 | 455.1 | 0.91% |
| | (high) | | |

Vermiculite is a hydrous, silicate material with a [(AlSi)₄O₁₀].(OH)₂.4H₂O repeat unit. Areas of the vermiculite in contact with hydrogen were consistently, visibly darkened when analyzed post-mortem indicating that the material was reduced at high temperatures in the presence of hydrogen. The material reduction may have caused porosity changes in the vermiculite seal that led to this greater leakage at high temperature, or volume changes in the vermiculite seal may have impacted the ultimate sealing pressure. Additionally, the water trapped within the layers of vermiculite is released at elevated temperatures including above 600° C. This may cause expansion, opening up and/or rupturing of the layers of the gasket. Graphite, on the other hand, is not deleteriously affected by reducing environments since it has no reducible species and does not experience the same issues with water. Pure graphite can, however, undergo oxidation in air beginning about ˜455° C. but does not appreciably occur until over ˜550° C. For instance, air was flowed through a stainless steel heat exchanger assembly sealed with multiple graphite seals while the exhaust composition was monitored using gas chromatography while the temperature was varied up to approximately 500° C. Even though the average temperature of the heat exchanger was hotter than 460° C. with potions of the assembly as hot as 500° C., the measured CO₂ concentration was approximately equivalent to the current average CO₂ concentration in ambient air (i.e, ˜418 ppm) and did not change appreciably over 3.5 days at this temperature. With the addition of special oxidation inhibitors, bulk graphite oxidation rates can be significantly reduced such that the thin edge exposure of gaskets to air at temperatures higher than 700° C. for extended periods of time is possible.

In accordance with various embodiments of the invention, oxidation inhibitors may include, consist essentially of, or consist of boron- and phosphorus-containing additives. Boron-containing additives include boric acid, boron carbide, boron powder and borate salts. Phosphorus-containing additives include organic phosphorus compounds such as tributylphosphate, phosphate esters, organophosphorus acids or inorganic phosphorus compounds such as phosphoric acid, phosphorus pentoxide, or neutral or acidic phosphate salts. Oxidation inhibitors may also include, consist essentially of, or consist of the oxides of boron and phosphorous and the metal salts of borates and phosphates and mixtures thereof. Oxidation inhibitors may also include, consist essentially of, or consist of, for example, ammonium phosphate, aluminum phosphate, zinc phosphate or boric acid.

Therefore, the first test showed that graphite may be a very effective stack gasket material and has been shown, at least in the SF test configuration, to be superior to vermiculite materials at minimizing gas leaks at temperatures as high as 650° C. The graphite material was also shown to be rather robust with minimal change in leak characteristics after many thermal cycles.

In the second test involving gaskets, graphite and vermiculite gasket materials were evaluated in a flow-through (FT) configuration, which more closely represents the flow conditions in a fuel cell stack. Much higher back pressures may be encountered in certain regions of the stack (e.g., the transition from the stack manifold to the flow field of each interconnect). To properly gauge the effect of higher back pressures, the degree of interfacial leakage for each seal was measured in the FT configuration. Gasket sheets were cut into disks with a hole in the middle and compressed at the high seating stress (i.e., ˜16.5 MPa) between the same two flanges used in the SF configuration of the first gasket test. In the FT configuration the BPR was downstream of the flanged assembly. For the FT configuration simple subtraction of the measured effluent flow from the known (calibrated) inlet flow yielded the interfacial leak rate. The BPR was used to vary the differential pressure between the inlet and outlet of the flange assembly from ˜0.5 psi to ˜5.5 psi at different temperatures (25° C., 200° C., 350° C., 500° C., and 650° C.).

The difference between the graphite and vermiculite gasket materials was similar at 350° C. and 500° C., but vermiculite gaskets exhibited consistently greater leakage. At 200° C. and at less than ˜1 psi, the fuel leakage is below 1% for both materials, whereas at 500° C. the vermiculite exhibits slightly above 1% leakage at only 0.5 psi. At low back pressures (i.e., ˜0.5 psi to ˜1.5 psi), the interfacial leak rate derived from the FT configuration tests was similar to that determined from the SF configuration tests.

FIG. 12 shows the degree of fuel leakage determined from the FT configuration measurements as a function of temperature (at 25° C., 200° C., 350° C., 500° C., 650° C.) for back pressures of 1 psi, 3 psi, and 4.5 psi. Additional data at 650° C. was collected only for the graphite gasket. Across all temperatures tested, the vermiculite gasket leaked more than the graphite gasket at each back pressure. Moreover, graphite gaskets appear to be less sensitive to changes in back pressure than vermiculite. For a back pressure of 1 psi and at lower temperatures, the graphite and vermiculite gaskets have similar interfacial fuel leak rates. At temperatures above ˜350° C., however, the interfacial leak rate of vermiculite gasket increases relative to that of the graphite gasket. As indicated in the highlighted portion of FIG. 12, between 200° C. and 350° C. the data for the vermiculite gasket at all backpressures shows a discontinuity in the downward sloping trends seen for both gasket materials. This increase in leakage rate is believed to be a result of reduction of vermiculite, which also changes color in the presence of hydrogen. Neither the color change nor the increase in leakage rate is observed for vermiculite when tested in air.

Although the leakage rate of vermiculite seals appears to increase when introduced to a reducing fuel environment, the performance is stable over time. Graphite also performed very well in reducing conditions and was also stable. Therefore, graphite gasket material was shown to have very good fuel leak characteristics that were better than vermiculite for all the evaluated temperatures and back-pressures.

In the third test involving gaskets, a hybrid graphite/vermiculite (anode) and vermiculite (cathode) seal configuration was tested in a single repeat unit with actual stainless steel stack hardware. The graphite/vermiculite seal combined a graphite layer and a vermiculite layer. Dense alumina (Al₂O₃) sheets were used as surrogate cells with the same overall geometry as 10 cm by 10 cm SOFCs used in an operational stack. This ensured there were no variations in cell flatness/edge sealing properties. The gasket was evaluated in a standard stack test setup with gas chromatography used to assess cross-over leak rates and stability. The fractions of N₂ and O₂ in the anode effluent (majority helium) were monitored with the GC, whereas in the cathode effluent (maj ority air) the fraction of helium was measured. The flow rates for the anode and the cathode sweep gases for such tests were both 100 sccm, which is lower than the typical air and fuel flow rates per repeat unit for cells of this size. These test conditions were chosen to obtain better resolution with the GC (i.e., relatively low flow rates were used at the inlets such that leakage was a larger percentage of the total flow rate). The pressure differential between cathode and anode were similar to expected operating conditions (<0.1 psid).

The gasket configuration for the third test had the following component arrangement (where “IC” stands for the interconnect (or endplate) with flow field): Anode IC/graphite|vermiculite/(glass) Al₂O₃ surrogate cell/vermiculite/Cathode IC

The overall stack assembly was clamped using several stainless steel tie-rods and nuts with a seating stress of less than ˜0.3 MPa on the gaskets. Leak tests were conducted at ˜650° C. with the anode inlet flow rate set to 100 sccm of helium, while the cathode inlet was set to 100 sccm of air. Negligible changes in CO in the anode exhaust were detected. Moreover, a post-test analysis revealed that the graphite did not appear to have undergone any noticeable oxidation, even at the edges of the graphite gasket that were exposed to the ambient air. As seen in FIG. 13, the helium cross-over from the anode to the cathode stays relatively constant over 50 hours. The increase in N₂ cross-over from the cathode to the anode beginning around 25 hours indicates the hybrid seal configuration did change slightly over time. In addition, the leak path does not seem preferential to small gas species like helium since the N₂ cross-over is larger the helium anode-to-cathode cross-over even at the beginning of the test. These observations are likely a result of the commonly observed phenomena of gasket creep known to occur for various gasket materials, including graphite gaskets. Over time the gasket relaxes and in the present case this is believed to have resulted in an increase of N₂ cross-over from the cathode stream to the anode stream. Gasket creep may be managed through mechanical improvements, such as the use of slightly increased sealing pressure or through the use of spring washers.

Therefore, the hybrid graphite/vermiculite (anode) and vermiculite (cathode) seal configuration of the third test was shown to have very good anode-to-cathode cross-over leak performance and acceptable cathode-to-anode cross-over leak performance, which may be further improved through stack design. Furthermore, in this seal configuration the vermiculite in the hybrid graphite/vermiculite gasket electrically insulates the anode and protects the graphite from oxidation at higher temperatures.

In the fourth test involving gaskets, a symmetric vermiculite (anode) and vermiculite (cathode) seal configuration was investigated. A dense alumina (Al₂O₃) sheet was used as a surrogate cell with the same overall geometry as 10 cm by 10 cm SOFCs used in an operational stack. The same test fixture as used in the third test was used to test a symmetric vermiculite seal configuration with the following arrangement: Anode IC/vermiculite/(glass) Al₂O₃ surrogate cell/vermiculite/Cathode IC.

The overall stack assembly was clamped using several stainless steel tie-rods and nuts with a seating stress of less than ˜0.3 MPa on the gaskets. Leak tests were conducted at ˜650° C. with the anode inlet flow rate set to 100 sccm of helium, while the cathode inlet was set to 100 sccm of air. As shown in FIG. 14, the cathode-to-anode cross-over (i.e., N₂ measured in the anode exhaust) initially has a similar value as the hybrid graphite/vermiculite configuration of the third test (FIG. 13) but does not increase as much over time. The helium cross-over from the anode to the cathode (i.e., helium measured in the cathode exhaust) was relatively high for the symmetric vermiculite seal configuration of the fourth test.

Considering the graphite used was a standard material, absent any special anti-oxidizing additives, the hybrid graphite/vermiculite configuration of the third test was tested in a fairly aggressive environment (i.e., oxidation should have been prevalent). Extrapolating from these results for a more relevant flow rate even as high as 1 LPM of hydrogen in the anode compartment, the hybrid graphite/vermiculite seal configuration of the third test would have an equivalent fuel cross-over of only ˜0.5%, whereas the symmetric vermiculite configuration of the fourth test would have an equivalent fuel cross-over of ˜1%. While the vermiculite does not creep over time, the material does experience a loss of CO₂ and H₂O from the mineral gasket and above 600° C. undergoes recrystallization. These two phenomena appear to mostly suppress the creep behavior that was observed with the graphite in the hybrid graphite/vermiculite configuration of the third test. From the FT configuration experiments of the second test, the graphite was observed to have superior sealing properties compared to vermiculite, at least when exposed to a reducing environment (e.g., hydrogen). The vermiculite was shown to react with H₂ but not with helium.

Therefore, the results from fourth test suggest that this seal configuration may be used in a stack. However, a comparison of the data presented in FIG. 13 and FIG. 14 show that the hybrid graphite/vermiculite seal configuration from the third test represent about a 50% reduction in fuel cross-over compared to the symmetric vermiculite (anode) and vermiculite (cathode) seal configuration from the fourth test. Furthermore, stability improvements to overcome gasket creep in graphite are possible without any major modifications to the stack design.

In the fifth test involving gaskets, a symmetric graphite (anode) and graphite (cathode) seal configuration was investigated. A dense alumina (Al₂O₃) sheet was used as a surrogate cell with the same overall geometry as 10 cm by 10 cm SOFCs used in an operational stack. The same test fixture as used in the third and fourth tests was used to test a symmetric graphite seal configuration with the following arrangement: Anode IC/graphite/Al₂O₃ surrogate cell i graphite/Cathode IC.

Unlike the third and fourth tests, the symmetric graphite seal configuration of the fifth test used no glass. The overall stack assembly was clamped using several stainless steel tie-rods and nuts with a seating stress of less than ˜0.3 MPa on the gaskets. FIG. 15 presents the anode-to-cathode cross-over leakage results at 500° C. when flowing 100 sccm of helium at the anode inlet and 100 sccm of air at the cathode inlet. FIG. 16 presents the cathode-to-anode cross-over percentage as a function of time. The cross-over leak rates are each less than 0.3%. This is a very impressive result, particularly since no glass was used in the symmetric graphite seal configuration of the fifth test and because graphite was exposed directly to air on the cathode side.

To assess the degree of graphite oxidation during the test, exhaust gas concentrations of CO₂ were measured, However, the change in CO₂ in the air exhaust was not resolvable below the 10 ppm measurement uncertainty for CO₂, indicating that the graphite gaskets experienced negligible oxidation. The lack of graphite degradation in air at lower temperatures enables the use of graphite for both anode and cathode seals.

The long-term stability of the graphite gasket configuration was assessed at 500° C. for approximately 2.5 weeks and the seal was very stable without appreciable change in leak rates. This was repeated in a separate test with the same configuration and yielded a similar result. The symmetric graphite seal configuration also performed well at 550° C. Post-test analyses revealed that the visual appearance of both the anode and cathode gaskets appeared unchanged after the exposure to temperatures as high as 550° C. and long-term exposure at 500° C. The small change in leak rates that occurred are therefore assumed to result from gasket creep, which may be compensated with the use of additional spring washers to retain a more constant seating stress on the gaskets.

The results from the fifth test have shown that graphite based gaskets may be used simultaneously for both the stack anode and cathode seal at lower operating temperatures (e.g., less than ˜550° C.). The symmetric graphite configuration was very stable at 500° C. for 2.5 weeks. Graphite materials with anti-oxidizing additives may be used as the anode and cathode seal up to temperatures as high as 700° C. While the configuration in the fifth test did not utilize any glass, better results may be possible for a graphite gasket used on both the anode and cathode sides. Furthermore, while graphite is relatively soft and conforms to sealing surfaces, the addition of glass on the anode and/or cathode side for this configuration may be beneficial for sealing real SOFCs, which may not be as flat as the ideal Al₂O₃ surrogate cell used in the fifth test, and for operation at higher temperatures.

In the sixth test involving gaskets, an asymmetric graphite (anode) and vermiculite (cathode) seal configuration was investigated with the following component arrangement: Anode IC/graphite/Al₂O₃ surrogate cell (glass)/vermiculite/Cathode IC.

A dense alumina (Al₂O₃) sheet was used as a surrogate cell with the same overall geometry as 10 cm by 10 cm SOFCs used in an operational stack. Like the third and fourth tests, the asymmetric graphite (anode) and vermiculite (cathode) seal configuration of the 6^{th} test used glass, except the glass was on the cathode side of the Al₂O₃ surrogate cell. The same test fixture as used in the third, fourth, and fifth tests was used to test this asymmetric seal configuration with more realistic operating conditions (500 sccm H₂, 1500 sccm air) without a helium tracer. The gasket configuration of the sixth test was evaluated at 650° C. The overall stack assembly was clamped using several stainless steel tie-rods and nuts with a seating stress of less than ˜0.3 MPa on the gaskets.

Gas chromatography was used to measure N₂ and CO₂ in the anode exhaust streams. The amount of H₂O in the cathode stream was measured using a relative humidity sensor adjusted for the actual temperature of the exhaust stream. FIG. 17A shows that the measured N₂ in the anode exhaust increased over time, likely due to the same gasket creep phenomenon observed with the hybrid graphite/vermiculite seal configuration of the third test. A corresponding increase in CO₂ in the anode exhaust is also observed (FIG. 17B), but the amount of CO₂ precisely matches the proportional amount in the cathode stream relative to the N₂ cross-over in the anode. For example, at 10 hours the measured N₂ concentration is and the CO? concentration is 10 ppm in the anode exhaust; the expected CO₂ originating from cathode air is ((2% N₂)/(79% N2)) (400 ppm CO2), which is equal to 10.1 ppm CO₂. The lack of any additional CO₂ provides additional evidence that the graphite gasket does not decompose even at 650° C. This is a particularly impressive result considering that in the asymmetric graphite (anode) and vermiculite (cathode) seal configuration of the sixth test there is only graphite on the anode (i.e., no glass) and because 1-12 was used rather than helium. Unlike the third, fourth, and fifth gasket-configuration tests, H₂O in the cathode exhaust was measured to determine the anode-to-cathode cross-over, because at 650° C. any H₂ that leaks to the cathode immediately reacts with oxygen to form steam. As shown in FIG. 17C, an increase in H₂O in the cathode exhaust is observed that matches the trend in N₂. cross-over. The nature of the leakage in the seal configuration of the sixth test appears to be more symmetric than in others (i.e., anode-to-cathode and cathode-to-anode leakage is similar), but the magnitudes are small. The presence of 2% to 6.5% N₂ in the exhaust corresponds to a cathode-to-anode cross-over percentage of only 0.7% to 2.2%, and the 0.1% to 0.2% H₂O in the cathode exhaust corresponds to 0.3% to 0.6% anode-to-cathode cross-over.

The sixth test showed that an asymmetric graphite (anode) and vermiculite (cathode) seal configuration may be used successfully at SOFC operating conditions up to at least 650° C. There is no apparent degradation of the graphite gasket and the overall seal is very good on both the anode and cathode side of the stack repeat unit. The graphite is unharmed in inert or reducing environments below 650° C. Similar tests at these temperatures have also confirmed that graphite undergoes no degradation even in high concentrations of steam (e.g., >40% by vol. H₂O from a steam reformer as might be expected in a full SOFC power system).

In a seventh test involving aluminum stack components, different aluminum alloys were evaluated to assess their mechanical integrity in a stack-like configuration and relevant SOFC operating conditions. Table 2 provides a summary of the melting point data for the different alloys evaluated for use in an SOFC stack. The melting point is given as a temperature range from the approximate solidus to the liquidus. Wrought alloys are separated into different categories based on the primary alloying elements. The 1XXX series of aluminum alloys (e.g., AL1100) have an aluminum concentration between approximately 99 wt % and approximately 99.99 wt % and have reasonably good corrosion resistance. The 6XXX series of aluminum (e.g, AL6061) is alloyed primarily with silicon and magnesium and has an aluminum concentration of approximately 95.7 wt % to approximately 98.9 wt %. The 2XXX series of aluminum (e.g., AL2024) is alloyed primarily with copper and has an aluminum concentration between approximately 92.5 wt % and approximately 96.7 wt %. The 7XXX series (e.g., AL7075) has an aluminum concentration of approximately 85.7 wt % to approximately 99 wt % and is primarily alloyed with zinc. The 3XXX, 4XXX, SXXX, and 8XXX series of aluminum were not tested in the seventh test. The 3XXX series of aluminum (e.g., AL3003) is primarily alloyed with manganese and has an aluminum concentration ranging from approximately 97.8 wt % to approximately 99.8 wt %. The 4XXX series is primarily alloyed with silicon and contains between approximately 85 wt % to approximately 98.3 wt % aluminum. The 5XXX series is primarily alloyed with magnesium and has an aluminum concentration ranging from approximately 93.5 wt % to approximately 99.3 wt %. The 8XXX series has approximately 87.5 wt % to approximately 99.3 wt % aluminum and is alloyed with a mix of different elements that do not fit in the other category series (e.g., primarily iron together with lithium, vanadium, germanium, silicon, manganese, titanium, zirconium, and/or copper). Note, that cast aluminum alloys use a slightly different nomenclature of the form #xx.x, where # is a number 1 through 8, which have same meaning as the categories as the wrought alloys (e.g, 1xx.x is the same as the 1XXX series).

TABLE 2
Melting point data for aluminum alloys
evaluated for use in an SOFC stack

| | | | Melting |
|---|---|---|---|
| | Min. Wt % | | Point |
| Aluminum Alloy | Aluminum | Alloying Elements | (° C.) |
| AL1100 | ≥99% | Cu, Fe, Mg, Si, Zn | 643-657 |
| (high purity) | | | |
| AL6061 | ~97.9% | Si, Mg, Cu, Mn | 582-652 |
| AL2024 | ~93.5% | Cu, Si, Mg, Cr | 502-638 |
| AL7075 | ~90% | Zn, Mg, Cu, Cr | 477-635 |
| (low purity) | | | |

Each alloy was evaluated using 5″ by 3″ or 3″ by 3″ pieces of aluminum that were either 0.063″ or 0.039″ thick and arranged in the following configuration: 430SS Endplate/430SS Interconnect/Aluminum Alloy/430SS Interconnect/430SS Endplate.

The 430SS interconnect used in these tests had flow field features (i.e., ribs and channels), while the aluminum alloy in the center of the assembly was flat or essentially flat and had a smooth surface finish before testing. The assembly was clamped using stainless steel tie rods and nuts with a load of approximately 1 MPa. A first sample of each aluminum material was evaluated at 400° C. A second sample of the same material was also evaluated 500° C.

The assembly was loaded into a temperature-controlled kiln and held at a constant temperature for 100 hours. The dimensions of each aluminum plate were measured before and after exposure to elevated temperatures and then a uniform stress was applied to the aluminum plates or sheets by clamping the plates between two stainless steel endplates. On either side of the aluminum plate or sheet was a stainless steel interconnect with a flow field to present a worst-case stress concentrator on the aluminum. While there was no bulk deformation, the aluminum alloys exhibited some minor surface indentations which lined up with the ribs of the stainless steel interconnect. Some aluminum alloys exhibited larger indentations than others. A non-contact optical profilometer (Keyence VR-3200) was used to quantify the degree of the surface deformations. For example, the average depth of the surface deformation for the AL6061 after testing at 500° C. was only 30 microns, whereas for AL1100 the deformation depth was 60 microns. Such deformations are insignificant, even for long-term use, for operation of an SOFC. While all of the aluminum alloys are deemed sufficient for the use in an aluminum stack, AL6061 appears to be the most robust material of those tested. Moreover, while higher purity alloys and pure aluminum materials have higher melting points, they will in some cases benefit from coatings to prevent or minimize surface deformation. Less pure aluminum alloys (e.g., AL6061, AL2024, or AL7075) may or may not benefit from such coatings. In terms of oxidation resistance, there were visual differences between the different alloys tested at 500° C. for 100 hours. Of the alloys tested, the surface of the AL1100 remained relatively shiny whereas the AL6061, AL2024, and AL7075 were dull in appearance. The surface of the AL6061 was not nearly as dull the AL2024 and AL7075, which had a similar appearance. Of the materials used, these low to middle purity aluminum alloys (alloys with approximately 90 wt % to 99 wt % Aluminum) seem to offer the best compromise between surface deformation and melting point for the temperatures tested in the seventh test. Of those alloys tested, those with approximately 95 wt % to 99 wt % aluminum seem to offer the best inherent resistance to oxidation. The higher impurity alloys tend to be stronger than the lower impurity alloys. For improved overall performance, the inherent oxidation resistance of higher impurity alloys may be improved by laminating, cladding, or coating a lower impurity aluminum to a core with a lower concentration of aluminum.

In an eighth test involving aluminum stack components, various coatings on 6061 aluminum and 400 series stainless steel interconnect substrate coupons were evaluated for stability at different temperatures. Materials investigated include titanium nitride (TiN), silver (Ag), manganese cobaltite ((Mn,Co)₄, or MCO), and a non-chromate process conversion coating (Iridite NCP). The Ag coating was deposited on stainless steel coupons using silver paste and a paint brush followed by annealing at ≥650° C. The silver paste was made from Ag flake and organic paste vehicle (solvent and binder). The MCO coating was deposited on stainless steel coupons using a slurry spray coat process, where the slurry was composed of MCO powder, solvent, and binder. The coating was annealed at ˜800° C., first in air and then a mixture of 3% H₂ and 97% N₂. The Iridite NCP was deposited on aluminum coupons by emersion of the test coupon in a chemical solution bath. TiN coatings were deposited on both 400 series stainless steel and 6061 aluminum coupons using a PVD process.

Each coupon was evaluated individually in a test setup that clamped the coupon in an alumina (Al₂O₃) fixture with a platinum current collector. The coupons were exposed only to stagnant air in a high-temperature kiln. Gold or silver wires were connected to the platinum current collectors on one end (in the hot zone), while the other ends of the wires were connected to a high-resolution multi-meter for four-point resistance measurements. FIG. 18 shows the area specific resistance (ASR) for TiN on AL6061, which was held at 500° C. in air for 12 hours. This ASR value was reasonably stable and represents the combined ASR of the TiN and AL6061. The nominal ASR is approximately 50 mΩ-cm² at 500° C. The ASR for the TiN coated aluminum tested at 400° C. was slightly lower (i.e., nominally ˜20 mΩ-cm²) than that of the sample tested at 500° C. The average ASR at 500° C. for the TiN is compared to the other coatings in Table 3.

TABLE 3
Summary of ASR values for coatings on interconnect at 500° C.

| Coating on Interconnect | ASR @ 500° C. (Ω-cm²) |
|---|---|
| TiN coating on 6061 aluminum | 0.052 |
| TiN coating on 400 series stainless steel | 0.023 |
| Indite NCP coating on 6061 aluminum | 0.090 |
| Ag coating 400 series stainless steel | 0.011 |
| MCO coating on 400 series stainless steel | 0.137 |

As-deposited and post-test SEM images of the TiN coating are shown in FIG. 19A and FIG. 19B, respectively. Note that the SEM sample preparation was less than ideal and there was some damage to the portions of the film for the as-deposited sample. The TiN coating was approximately 2 microns thick and conformed well to the surface of the substrate. Despite a minor change in color that all TiN films experienced after exposure to elevated temperatures, the post-test film looks mostly unchanged compared to the as-deposited film. While TiN is known to begin to oxidize above approximately 500° C. to 550° C., this does not appear to impact its performance for use in SOFCs and related devices. Moreover, it has also been shown that the onset temperature of oxidation for TiN can be increased to ≥700° C. with ion implantation (e.g., Al ion implantation) into TiN films. SEM images of the silver paste coating showed both closed and open porosity with a film thickness of ˜15-20 microns. SEM images of the MCO coating showed a thickness of ˜7 microns.

The results of the eighth test demonstrate that some coatings have superior properties than others for SOFC applications. The TiN coating was shown to provide a good electrical coating on both aluminum alloy and stainless steel at elevated temperatures. The Ag coating on stainless steel (annealed at ≥650° C.) had very good electrical performance. The Iridite NCP coating on aluminum had sufficient electrical performance as well. The MCO coating on stainless steel is likely too resistive to be useful in the SOFC stack at 500° C.

In a ninth test, three 5 cm by 5 cm Ni-cermet cells were tested in a stack using stainless steel interconnects. The stainless steel interconnects were made from 400 series stainless steel and had various flow field features (i.e., ribs and channels). Silver coatings were applied with a brush using a paste made from silver powder and organic paste vehicle (solvent and binder). The silver coatings were applied to the flow field and busbar and voltage probe tab connections on each stainless steel interconnect, dried, and subsequently annealed at ≥650° C. Each 5 cm by 5 cm cell featured a Ni-cermet anode, GDC electrolyte, and LSCF-GDC cathode. A symmetric vermiculite gasket arrangement similar to the configuration in the third test was used but with glass on both the anode and cathode sides of the cell. Together with stainless steel endplates the overall stack assembly was clamped using several stainless steel tie-rods and nuts with a seating stress of less than ˜0.3 MPa on the gaskets. Gas inlet and outlet manifolds with air and fuel preheat coils were connected to the SOFC stack. Electrical current connections were made via stainless steel busbars. Voltage probe measurements were made with separate wires. The assembly was loaded into a computer-controlled kiln. Gas inlets were connected to computer-controlled MFCs, whereas the exhaust outlets were vented. Gas chromatography was used to assess cross-over leaks. The stack was operated between 650° C. and 500° C. using humidified hydrogen as the anode stream fuel source and compressor air for the cathode stream. The nickel oxide in the Ni-cermet anode was reduced at 650° C. Electrical characterization was performed using appropriate electronic load and impedance analyzer hardware.

The seal quality for the stack with the stainless steel interconnects was excellent with only ˜0.3% N₂ detected in the fuel (anode) exhaust stream, which is essentially a cathode-to-anode cross-over of less than 0.1%. Each of the three cells in the SOFC stack had roughly the same performance at each test condition. At 650° C. and with zero external load current, the cells had an open circuit potential (OCP) of approximately 0.83 V and a total ASR (i.e., cells, interconnects, and current collectors) of 0.2 Ω-cm². The OCP and ASR at 550° C. were 0.89 V and 1.00 Ω-cm², respectively. At 500° C., the OCP was 0.90 V and the ASR was 2.11 Ω-cm². The power density of the cells at an operating voltage of 0.75 V was 0.12 W/ cm² at 550° C. and 0.06 W/cm² at 500° C. For an operating voltage of 0.60 V the power density was 0.18 W/cm² at 550° C. and 0.09 W/cm² at 500° C. These results indicate that silver-coated stainless steel interconnects are a viable combination for SOFC stack operation at these operating temperatures.

In a tenth test involving aluminum stack components, a single-cell stack was assembled using silver-coated aluminum interconnects and a 5 cm by 5 cm cell. The aluminum interconnects were made from 6061 aluminum and had various flow field features (e.g., ribs and channels) with the same geometry as the stainless steel interconnect in the ninth test. Electrical current connections were made via stainless steel busbars. Voltage probe measurement were made with separate wires. Silver coatings were applied with a brush using a paste made from silver flake and organic paste vehicle (solvent and binder). The silver coating was applied to the flow field and to the busbar and voltage probe connections on each aluminum interconnect. The silver coatings on the aluminum were annealed around 500° C., whereas the silver coatings on the stainless steel busbars were annealed at ≥650° C. The 5 cm by 5 cm cell had a Ni-cermet anode, GDC electrolyte, and LSCF-GDC cathode. A symmetric vermiculite gasket arrangement was used. The seal configuration was similar to that used in the third test but instead of glass on the cell's anode, RTV silicone sealant was used on the cathode side of the cell. Together with stainless steel endplates, the overall stack assembly was clamped using several stainless tie-rods and nuts with a seating stress of less than ˜0.3 MPa on the gaskets. Gas inlet and outlet manifolds with air and fuel preheat coils were connected to the stack endplates. After current busbars and voltage wires were connected, the overall assembly was loaded into a computer-controlled kiln. Gas inlets were connected to computer-controlled MFCs, whereas the exhaust outlets were vented. Gas chromatography was used to assess cross-over leaks. Electrical characterization was performed using appropriate electronic load and impedance analyzer hardware.

The stack assembly in tenth test was operated only as high as ˜500° C. After the cell was reduced in hydrogen at 475° C., GC measurements indicated that the cathode-to-anode cross-over was only ˜0.5%. While not as low as the cross-over leakage observed in the ninth test, the seal quality in the tenth test is still considered very good and may have been improved if the RTV seal had been used on the anode side of the cell because of the reducing gas ambient. Unfortunately, the silver-coated aluminum interconnects of the tenth test resulted in abnormally low OCP and high ASR values (e.g., ˜0.4. V OCP and >7 Ω-cm² at 500° C.).

The brushed on silver coating, however, did not perform well and was determined to be the reason for the high ASR and low OCP. While the silver coatings from the ninth test were fairly well adhered due to the use of an anneal at ≥650° C., the aluminum coatings were only annealed at approximately 500° C. The use of a lower anneal temperature resulted in poor adhesion and high interfacial contact resistance between the coating and the aluminum interconnect. This resulted in a large voltage drop that caused the abnormally low OCP and the very high ASR. If the silver can adhere better to the aluminum (e.g., if a different process such as electroplating were used), the results are expected to be better. Therefore, the tenth test demonstrated that silver coatings with inadequate adhesion on aluminum are not appropriate for use in SOFC stacks; as implied above, silver coating that are well-adhered (e.g., annealed at ≥650° C.) are appropriate for us in SOFC stacks.

Despite the relatively high temperature, the use of RTV with the vermiculite gaskets resulted in a good seal. In fact, in another instance, the same seal configuration resulted in a seal with a cathode-to-anode cross-over of less than 0.1%. The bond between RTV silicone and ceramic or between RTV silicone and metal is reasonably strong even after exposure for extended periods to SOFC operating conditions. Post-test scanning electron microscopy (SEM) images revealed that the RTV silicone formed a glassy-like seal. The fact that the RTV silicone formed such a good seal at 500° C. was an unexpected result because all of the leading suppliers specify RTV silicone as having a maximum temperature range of 350-400° C. Therefore, the tenth test also demonstrated that the use of RTV silicone can yield a high quality seal for SOFCs.

In an eleventh test involving aluminum interconnects having a titanium nitride (TiN) coating, a single-cell stack was assembled using TiN-coated aluminum interconnects and a 5 cm by 5 cm cell. The aluminum interconnects were composed of 6061 aluminum and had various flow field features (e.g., ribs and channels) with the same geometry as the stainless steel interconnect in the ninth test and the silver-coated aluminum interconnect from the tenth test. An electrically conductive TiN coating was deposited in the flow field active area (i.e., the area generally overlapping with the cell in a stack repeat unit). A TiN coating was also deposited on the busbar and voltage probe tabs of the aluminum interconnect.

The TiN coatings were deposited using physical vapor deposition (PVD). A shadow mask was used to selectively coat certain regions of the interconnect. The resulting films were gold in color. The TiN coatings on the interconnect were nominally 2 microns thick.

The 5 cm by 5 cm cell had a Ni-cermet anode, GDC electrolyte, and LSCF-GDC cathode. A symmetric vermiculite gasket arrangement was used. The seal configuration was similar to that used in the third and tenth test but instead of glass on the cell's anode or RTV silicone on the cell's cathode, no other sealant was used in addition to the vermiculite. Together with stainless steel endplates the overall stack as assembly was clamped using several stainless steel tie-rods and nuts with a seating stress of less than ˜0.3 MPa on the gaskets. Gas inlet and outlet manifolds with air and fuel preheat coils were connected to the stack endplates. Electrical current connections were made via stainless steel busbars, which had silver coatings that were annealed at ≥650° C. Voltage probe measurements were made with separate wires. The assembly was loaded into a computer-controlled kiln. Gas inlets were connected to computer-controlled MFCs, whereas the exhaust outlets were vented. The nickel oxide in the Ni-cermet anode was reduced at 475° C. Gas chromatography was used to assess cross-over leaks. Electrical characterization was performed using appropriate electronic load and impedance analyzer hardware.

GC measurements of the anode exhaust indicated less than 0.8% N₂, which equates to less than 0.3% cathode-to-anode cross-over. This is very similar to the seal results in other aluminum interconnect tests, including the results from the tenth test. The cell's electrical characteristics were measured at approximately 475° C., 500° C., 515° C., 530° C., and 550° C.

FIG. 20 shows the measured voltage and power density characteristics as a function of current density (A/cm²) between 475° C. and 550° C. The OCP at 475° C. and 515° C. was 0.88 V and decreased slightly to 0.87 V as the temperature increased to 550° C. The ASR at 515° C. was 1.24 Ω-cm², while at 550° C. the ASR was 0.74 Ω-cm². This resulted in a maximum power density (MPD) of 0.15 W/cm² and 0.24 W/cm² at 515° C. and 550° C., respectively. At 550° C. and an operating voltage of 0.75 V, the cell in the eleventh test produced 0.09 W/cm² at 0.12 A/cm².

The performance of the Ni-cermet cell with TiN-coated aluminum interconnect in the eleventh test (reduced at 475° C.) compares well with Ni-cermet cell with Ag-coated stainless interconnect in the ninth test (reduced at 650° C.). Table 4 summarizes the OCP, ASR, and power density (PD) results for the two tests. At both 500° C. and 550° C., the cell from the eleventh test had about a 20 mV lower OCP than the cell from the ninth test. The slightly lower OCP for the cell in the eleventh test is believed to be due to pinholes in the electrolyte of the cell used in that test. These results are important for multiple reasons, including the fact that the aluminum stack components worked properly with an operational SOFC. Moreover, when the anode of a Ni-cermet SOFC is reduced at lower temperature (e.g., less than ˜600° C.), the slower reduction kinetics may yield a less optimal anode microstructure. Past microstructural analyses have shown that nickel wetting issues when Ni-cermet cells are reduced at lower temperatures may lead to poor electrical connectivity, which may result in cells with large voltage drops, and therefore low OCPs, or simply result in high ASRs. Yet, the performance from the eleventh test was acceptable.

TABLE 4
Electrical results summary at 500° C. and 550° C. for
the cell with TiN-coated aluminum interconnect (Eleventh Test)
and the cell with Ag-coated stainless steel interconnect (Ninth Test)

| | 500° C. | | 550° C. | |
|---|---|---|---|---|
| | | Stainless | | Stainless |
| | Aluminum | Steel | Aluminum | Steel |
| | Inter- | Inter- | Inter- | Inter- |
| | connect | connect | connect | connect |
| | (11^{th} | (9^{th} | (11^{th} | (9^{th} |
| Measured Values | Test) | Test) | Test) | Test) |
| OCP (V) | 0.88 | 0.90 | 0.87 | 0.89 |
| ASR (Ω-cm²) | 1.56 | 2.11 | 0.74 | 1.00 |
| PD at 0.75 V (W/cm²) | 0.05 | 0.06 | 0.09 | 0.12 |
| PD at 0.60 V (W/cm²) | 0.10 | 0.09 | 0.20 | 0.18 |

While the OCP of the single-cell stack from the ninth test was only about 3% higher than the single-cell stack from the eleventh test, the latter had about a 25% lower ASR than the former at both 500° C. and 550° C. This results in similar power density characteristics at both operating temperatures. However, the higher OCP of the single-cell stack from the ninth test results in a slightly higher power density at 0.75 V than the single-cell stack from the eleventh test, with the gap between them closing at lower-temperature operation. At higher current densities, the single-cell stack from the ninth and eleventh tests also displayed similar power densities. However, the single-cell stack from the eleventh test had a higher power density at an operating voltage of 0.6 V due to a lower ASR compared to the single-cell stack from the ninth test. While the single-cell stack from the ninth test was not characterized up to the MPD, the highest power density recorded for that test at 500° C. was 0.1 W/cm² at 0.2 A/cm² and an operating voltage of 0.52 V. The single-cell stack from the eleventh test produced 0.11 W/cm at 0.2 A/cm² and 0.55 V. The MPD of the single-cell stack from the eleventh test was 0.12 W/cm² at 500° C. The first ˜120 hours of operation for the cell stack from the eleventh test involved anode-reduction, cell-conditioning steps, and subsequent characterization between 475° C. and 550° C. (e.g., current-voltage, transient response, and cross-over leak measurements). After the initial characterization, the cell stack was held at a constant current of 0.21 A/cm² at 515° C. for 300 hours (i.e., from about 120 hours to 420 hours). As seen in FIG. 21, the voltage under constant current operating conditions did not change appreciably over this period of time. At around 300 hours into the test the current dropped to zero amps briefly, which shows that the OCP also did not change during this period of time. Moreover, GC-based leak rate measurements show that there was essentially no change in the cathode-to-anode cross-over leak rate during the entire constant current portion of the eleventh test.

Once the eleventh test was complete and the stack was cooled, a pressure decay test at room temperature has essentially the same result as that of a similar measurement made before the eleventh test. These results confirm the integrity of the seal. After the stack was disassembled, the components were inspected for visual anomalies to gauge the impact of testing at temperatures as high as 550° C. and the overall high-temperature exposure during the >400 hour test duration on the aluminum interconnect. There were no indications of deformation or other issues with the interconnect.

A multi-meter was used to compare the post-test, room-temperature resistance of different regions of the aluminum interconnects that were used in the eleventh test. The electrical resistance was measured from the TiN coating in the active area of the interconnect (i.e., the area generally overlapping with the cell in a repeat unit) to the TiN coating in the region of the interconnect where the electrical connection is made with the busbar. Electrical resistance was also measured over the same distance but in the uncoated region of the aluminum interconnect. The room temperature resistance of the coated region was similar to that before the eleventh test regardless of whether the measurement was made on the anode-side or cathode-side interconnect. Before the test, the uncoated and coated regions had a similar room temperature resistance. However, after the eleventh test, the resistance of the uncoated region was as much as 10³ to 10⁶ times more resistive than the coated region. The uncoated region oxidized, forming an insulating native oxide (i.e., Al₂O₃) film. There were certain areas of the uncoated region of the aluminum that had lower resistance values, though the measured resistance was still higher than the coated region of the interconnect. Because these areas coincided with regions in which the gasket was in contact with the interconnect, the gasket may have locally lowered the oxidation rate and essentially protected the aluminum from more aggressive oxidation during the test.

The result from the eleventh test showed that the aluminum components (e.g., aluminum interconnects) may be successfully used in stacks at temperatures at least as high as 550° C. and for over 400 hours with performance comparable to stainless steel components. The results show that such aluminum components may be used with ceramic SOFCs despite the fact that the thermal expansion coefficient of the aluminum is roughly twice that of the SOFC (i.e., approximately 20 ppm/° C. for aluminum versus approximately 12 ppm/° C. for the SOFC). The TiN coating has a sufficiently high conductivity and durability in both oxidizing and reducing environments for the test conditions of the eleventh test. The native oxide that forms on the uncoated regions of the aluminum interconnect is electrically insulating. In some stack designs an insulating layer such as this may be advantageous to prevent the formation of electrical shorts within the stack. After coating the desired portions of the interconnect with an electrically conductive layer such a TiN, the native oxide may be formed via, for example, after exposure of the interconnect to an oxidizing environment at elevated temperatures. The native oxide may be formed prior to stack assembly or in-situ as was done in the eleventh test. Formation of native oxide insulating layers in this manner may be more advantageous than the use of additional coatings of insulating materials.

In a twelfth test that involved modeling of the use of aluminum stack components to assess the predicted impact on the mechanical, thermo-mechanical, and thermal performance of an aluminum stack. A custom multi-physics model was used to predict/simulate the impact of aluminum stack components on contact pressure on the ceramic cell and room-temperature deformation of the aluminum components after assembly of a stack. The multi-physics model was also used to assess the impact of the aluminum stack components on the thermal gradients within an operating stack. The multi-physics model used realistic component geometries. A simple spreadsheet model was used to calculate the total thermal expansion of an aluminum-component stack with a stainless steel-component stack at operating various operating temperatures. Another spreadsheet model was used to assess differences in thermal response between aluminum and stainless steel stack components. Models utilized thermo-physical data for the materials of interest and relevant geometry (actual or simplified) for the stack components.

The multi-physics model was to evaluate the impact of aluminum stack materials on the mechanical integrity of the stack. A multi-cell stack assembly was investigated at room temperature with the appropriate boundary conditions to replicate conditions experienced during stack assembly. The local strain tensor distributions in the stack after assembly were compared for aluminum and stainless steel stack components. The contact pressure on the ceramic cell was similar for both materials and within acceptable ranges (i.e., less than 0.02 MPa), though the contact pressure on the cell is slightly higher when aluminum interconnects are used. Moreover, the model simulation predicts that neither the aluminum nor the stainless steel components should deform during assembly of a stack.

A stack contains many components which are composed of many different materials and that may have different shapes and sizes. When the stack is heated to elevated temperatures the different components within the stack may behave differently from one another. For example, differences in thermal expansion of the stack components may create excessive thermal stress that may deform parts or even cause the ceramic cells or seal materials to fracture. A spreadsheet model was used to compare the mechanical stress distribution within the stack due to differences in thermal expansion for stainless steel interconnects versus interconnects made of aluminum or copper. The thermal expansion coefficient (TEC) of aluminum ranges from approximately 19 μm/m/° C. to 24 μm/m/° C. depending on the alloy and temperature range. The TEC of 400 series stainless steels is on the order of 10 μm/m/° C. to 13 μm/m/° C., whereas for 300 series stainless steels the TEC is between approximately 14 μm/m/° C. to 18 μm/m/° C. For copper the TEC is ˜17 μm/m/° C., whereas the TEC of copper alloys can vary between 16 μm/m/° C. and 22 μm/m/° C.

Stacks with stainless steel components are well known to be sufficiently robust and may handle the thermal stresses from TEC mismatch that are experienced at temperatures even as high as 750° C., for example. While aluminum has a much higher thermal expansion than 400 series stainless steel (e.g., as much as approximately twice as high), the operational window for aluminum based stacks is lower with a higher end operating temperature no higher than perhaps approximately 650° C. The thermal expansion that occurs in the range of anticipated operating temperatures (i.e., ˜400° C. to ˜600° C.) is between ˜88% to ˜130% that of the known acceptable expansion. Moreover, the eleventh test showed that an aluminum stack operates well up to at least 550° C. Therefore, the model predicts that despite the much higher thermal expansion coefficient (CTE) of aluminum, the mechanical stress in the stack from TEC mismatch is not significantly increased given the operating temperature range compared to components made of 400 series stainless steel.

The multi-physics model was used to investigate whether there might be any advantages of an aluminum interconnects with respect to temperature gradients within the stack. The thermal conductivity of aluminum is ˜4.5 times higher than that of stainless steel. Moreover, copper has twice the thermal conductivity of aluminum (i.e., ˜9 times higher than that of stainless steel). Two different types of simulations were run to determine how aluminum and copper influence the temperature distributions across cells and the stack. The first type of simulation examined differences in temperature distribution across a single repeat unit from inlet to outlet. The second type of simulation focused on changes in temperature uniformities across the stack (i.e., how temperature varies from the bottom to the top of the stack).

The first type of thermal gradient simulation was run for 400 series stainless steel, aluminum, and copper materials at an operating temperature of 450° C. and 650° C. The results from the test showed major improvements in temperature uniformity for both aluminum and copper. As temperature decreases, the temperature gradient developed for a given material decreases slightly. Regardless, the difference in thermal uniformity between any two of the tested materials was fairly constant at each of the operating temperatures (i.e., thermal uniformity changes with temperature were consistent among the materials). The simulation predicts a maximum temperature difference between two points on the repeat unit for the aluminum interconnect at 450° C. is ˜50% smaller than that for stainless steel interconnect. For copper, the maximum temperature difference is ˜65% smaller than for stainless steel. Such improvements are important for a variety of reasons, including the lessening of thermal stress within the cell, which results in a more robust cell stack.

The second type of thermal gradient simulation was run at 650° C. and 550° C. for both aluminum and stainless steel stack components. The maximum temperature difference for each repeat unit is more uniform (i.e., more similar) at the lower operating temperature, regardless of the interconnect material. However, the aluminum material still provides a significantly more uniform thermal profile across the stack at both temperatures. At 650° C., the use of aluminum stack components results in a ˜41% improvement in thermal uniformity across the stack compared to the use of stainless steel components. At 550° C., aluminum stack components provide a ˜72% improvement in temperature uniformity across the stack. Such improvements in the thermal uniformity across the stack allow additional power to be produced within the stack since the relatively cooler top and bottom portions of the stack will be less likely to limit the hotter, middle section from producing additional power. The superior thermal uniformity also decreases the parasitic losses associated with the system blower (i.e., boosts the system efficiency and reduces capital equipment costs) because less excess air is needed to cool the temperature extremes within the stack.

A stack that heats or cools quickly may be desirable depending on the particular application. A stack's thermal response depends on the mass of stack components, the heat capacity of the materials, and the magnitude of change in temperature. The thermal response of stainless steel, aluminum, and copper materials were compared using a spreadsheet model. The thermal conductivity and heat capacity of aluminum are ˜4.5 times and ˜1.9 times higher, respectively, than stainless steel. For copper, on the other hand, while the thermal conductivity is ˜9 times higher than for stainless steel, the heat capacity is actually ˜19% lower than for stainless steel. Assuming stack components (e.g., endplates and interconnects) of the same size but made of different materials, an aluminum stack has a thermal response that is 30% to 40% faster than stainless steel depending on the alloy of aluminum or stainless steel that is considered. Copper has a thermal response that is 7% to 14% faster than stainless steel.

In a thirteenth test, two different adhesives were used to join a vermiculite gasket and a graphite gasket to each other as a hybrid gasket in the manner of FIG. 5A. A wet coating of a ceramic adhesive (i.e., Corr-Paint 30XX) was applied to one side of a vermiculite sheet gasket and to one side of a graphite sheet gasket. After application of the adhesive, the adhesive-sides of the two gasket materials were placed in contact with each other. Pressure was then either applied lightly by hand until the layers stuck to each other or higher pressure was applied in a uniaxial press. The samples with adhesive that were pressed in the uniaxial press were compressed at 1 MPa. As a control, a graphite gasket and a vermiculite gasket were compressed at 1 MPa in the uniaxial press without the use of an adhesive. The two layers in the hybrid gasket that used no adhesive (compressed to 1 MPa) did not adhere to each other even before the heat treatment. The same result occurred when the hybrid gasket with no adhesive was compressed to 5 MPa.

The hybrid gasket with no adhesive required 26 MPa of compression before the layers stuck to each other. Two samples for each configuration were prepared and heated to 650° C. in air for 24 hours. For the hybrid gasket with no adhesive, only one sample (the sample compressed to 26 MPa) was given the heat treatment.

After the heat treatment, one of the two samples with adhesive that was lightly compressed by hand had partially delaminated. The second of these samples remained fully adhered. Both samples of the hybrid gasket with adhesive that was compressed at 1 MPa were fully intact after heat treatment without any signs of delamination. The hybrid gasket without adhesive that was compressed to 26 MPa fully delaminated after the heat treatment. Therefore, the thirteenth test showed that an adhesive may help adhere layers in a hybrid gasket that can be used in a solid oxide fuel cell stack.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A solid oxide fuel cell device comprising:
a bottom endplate;
a top endplate;
disposed between the top and bottom endplates, a plurality of repeat units each comprising:
a cell comprising (i) a cathode, (ii) a solid ceramic electrolyte, and (iii) an anode for producing electricity through oxidation and reduction reactions involving a fuel and an oxygen source,
a solid, electrically conductive interconnect plate for conducting electrical current from the cell, and
disposed between the interconnect plate and the cell at least at a periphery of the repeat unit, a seal for reducing gas leakage from the repeat unit, wherein the interconnect plate and the cell are electrically insulated from each other at the seal; and
a coating disposed on at least one of the interconnect plate, the bottom endplate, or the top endplate, the coating comprising at least one of graphite, copper, aluminum, a carbide ceramic, a nitride ceramic, a conversion coating, or an aluminum intermetallic.

2. The device of claim 1, wherein the interconnect plate is a terminal interconnect plate.

3. The device of claim 1, wherein the coating is a cladding.

4. The device of claim 1, wherein the coating comprises a plurality of layers, at least a first one of the layers comprising a nitride ceramic and at least a second one of the layers comprising a metal.

5. The device of claim 4, wherein the metal comprises aluminum.

6. The device of claim 1, wherein the repeat units are electrically connected in series.

7. The device of claim 1, wherein the seal comprises graphite.

8. The device of claim 1, wherein the interconnect plate comprises stainless steel or a nickel-based superalloy.

9. The device of claim 1, wherein the interconnect plate comprises at least one of graphite, aluminum, or copper.

10. The device of claim 1, wherein the seal comprises at least one of glass, a brazing alloy, talc, mica, vermiculite, asbestos, a ceramic material, or a polymer material.

11. The device of claim 1, wherein the interconnect plate defines a plurality of protruding contact features for electrically connecting the interconnect plate to the cell.

12. The device of claim 11, further comprising an electrically conductive coating or cladding disposed over at least top surfaces of the contact features.

13. The device of claim 1, wherein the interconnect plate defines one or more flow channels for conduction of the fuel and/or of the oxygen source therethrough.

14. The device of claim 1, further comprising an electrically conductive porous or mesh current collector disposed between and in contact with the cell and the interconnect plate.

15. The device of claim 1, further comprising an external seal disposed around the periphery of the repeat unit and encapsulating at least one of the interconnect plate or the seal to reduce oxidation thereof.

16. The device of claim 1, further comprising:
an electrically insulating first layer disposed between the seal and the interconnect plate; and/or
an electrically insulating second layer disposed between the seal and the cell.

17. The device of claim 1, wherein the seal comprises first and second layers, the first and second layers comprising different materials.

18. The device of claim 17, wherein the first or second layer is electrically conductive.

19. The device of claim 1, further comprising:
an electrically insulating first coating disposed on a first surface of the seal; and/or
an electrically insulating second coating disposed on a second surface of the seal opposite the first surface.

20. The device of claim 1, wherein at least one of the top endplate or the bottom endplate comprises at least one of graphite, aluminum, or copper.

21. The device of claim 1, wherein the plurality of repeat units are electrically connected to the top endplate and the bottom endplate.

22. The device of claim 1, wherein the plurality of repeat units are not electrically connected to the top endplate and the bottom endplate.

23. The device of claim 22, further comprising:
a top terminal interconnect plate (i) disposed between the top endplate and the plurality of repeat units and (ii) electrically connected to the plurality of repeat units; and
a bottom terminal interconnect plate (i) disposed between the bottom endplate and the plurality of repeat units and (ii) electrically connected to the plurality of repeat units.

24. The device of claim 1, wherein a peripheral edge of the interconnect plate is shaped to directly contact the cell of an adjacent repeat unit without a seal therebetween.

25.-52. (canceled)
